(19) United States
(12) Patent Application Publication
(10) Pub. No.: US 2026/0273388 A1
(43) Pub. Date: Sep. 17, 2026

(54) INTERACTIVE TANGIBLE GAMING SYSTEM

(71) Applicant: Harris Hill Products Inc., New York, NY (US)

(72) Inventors: Brynn Putnam, New York, NY (US); Ryan Measel, Forest Hills, NY (US); Nicole Aptekar, Brooklyn, NY (US); Rolf Lakaemper, Munich (DE); Pavel Vechersky, Aliso Viejo, CA (US); Michael Cole, New York, NY (US); Jan Elseberg, Belm (DE)

(21) Appl. No.: 19/563,835

(22) Filed: Mar. 11, 2026

Related U.S. Application Data
(60) Provisional application No. 63/772,244, filed on Mar. 14, 2025.
(60) Provisional application No. 63/905,824, filed on Oct. 27, 2025.

(51) Int. Cl. A63F 9/24; A63F 9/00; G06F 3/041; G06F 3/044

(52) U.S. Cl. CPC A63F 9/24; A63F 9/001; G06F 3/04144; G06F 3/0446; A63F 2009/0033; A63F 2009/0049; A63F 2009/2457

(57) ABSTRACT

In some embodiments, an interactive tangible gaming system is presented. An interactive tangible gaming system may include a smart gaming surface comprising a digital display having a capacitive layer and a processor in communication with the digital display and the capacitive layer. The system may further include a gaming object configured to interact with the smart gaming surface and comprising a capacitive element having a capacitive signature. Upon interaction between the gaming object and the smart gaming surface, the processor may be configured to obtain the capacitive signature via the capacitive layer and cause the digital display to display one or more graphical elements based on the capacitive signature.

### CROSS-REFERENCE TO RELATED APPLICATIONS

This application claims priority to and the benefit of U.S. Prov. App. No. 63/772,244, filed Mar. 14, 2025, and U.S. Prov. App. No. 63/905,824, filed Oct. 27, 2025, each of which is incorporated by reference in their entirety.

### TECHNICAL FIELD

The present disclosure relates to gaming systems. In particular, the present disclosure relates to an interactive tangible gaming system.

### SUMMARY

In some embodiments, an interactive tangible gaming system is presented. An interactive tangible gaming system may include a smart gaming surface comprising a digital display having a capacitive layer and a processor in communication with the digital display and the capacitive layer. The system may further include a gaming object configured to interact with the smart gaming surface and comprising a capacitive element having a capacitive signature. Upon interaction between the gaming object and the smart gaming surface, the processor may be configured to obtain the capacitive signature via the capacitive layer and cause the digital display to display one or more graphical elements based on the capacitive signature.

In some embodiments, a computer-implemented method of displaying one or more graphical elements on a display screen is presented. The method may include providing a smart gaming surface comprising a digital display having a capacitive layer. The method may further include receiving, at a processor of the smart gaming surface, an electrical signal from the capacitive layer in response to interaction between the capacitive layer and a capacitive element of a gaming object. The method may further include modifying, via the processor of the smart gaming surface, the digital display to display the one or more graphical elements based on the interaction between the capacitive layer and the capacitive element.

### BRIEF DESCRIPTION OF THE DRAWINGS

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a block diagram illustrating an interactive tangible gaming system;

FIG. 2 is an exploded view of a smart gaming surface according to an embodiment;

FIG. 3 is an illustration of a plurality of gaming objects according to an embodiment;

FIG. 4 is an illustration of a smart gaming surface with a plurality of gaming objects according to an embodiment;

FIG. 5 is an illustration of a smart gaming surface configured to detect large area input, touch input, and gaming object input according to an embodiment;

FIG. 6 is an illustration of an application executing on a smart gaming surface according to an embodiment;

FIG. 7 is an illustration of nested gaming objects on a smart gaming surface according to an embodiment;

FIG. 8 is an illustration of a multi-input gaming object according to an embodiment; and

FIG. 9 is a flowchart illustrating a method of operating an interactive tangible gaming system according to an embodiment.

### DETAILED DESCRIPTION

Modern touch-screen systems are designed primarily for single-user interaction and face significant technical limitations when applied to multi-user, tangible object-based gaming scenarios. Conventional capacitive touch systems are optimized to detect finger touches while rejecting other contacts, making them unsuitable for detecting passive tangible objects placed on the display surface. These systems typically lack the capability to distinguish between intentional finger inputs and incidental contacts from palms, arms, or other body parts resting on the surface during multi-user interaction. Additionally, conventional touch systems struggle to maintain accurate tracking of multiple simultaneous touch inputs from different users, often resulting in finger identity confusion when multiple contacts occur in close temporal or spatial proximity. Furthermore, existing systems do not provide mechanisms for detecting and identifying passive tangible objects through their capacitive signatures, nor do they support the concurrent processing of multiple input modalities including touch input, tangible object input, and hand configuration input. Manufacturing and quality assurance of tangible objects for use with capacitive touch systems present additional challenges, as consistent detection capabilities must be maintained across different hardware units and environmental conditions.

In some embodiments, the present disclosure addresses these technical limitations through several novel solutions. The system may employ a unified multi-modal input processing pipeline configured to concurrently detect, classify, and track multiple input modalities including finger touch inputs, passive tangible gaming objects, and hand configurations through a single capacitive sensing layer. The system may utilize machine learning-based classification operating directly on raw capacitive frame data to distinguish valid inputs from noise contacts such as palms, arms, elbows, and other unintended contacts, while maintaining detection of valid inputs adjacent to or overlapping with noise regions. The system may implement velocity-based and acceleration-based tracking algorithms that apply physical motion constraints of human fingers to maintain correct contact identity across frames and prevent finger identity confusion during simultaneous lift and touch events in multi-user scenarios. In some embodiments, the machine learning-based classification model may be integrated directly into the input processing pipeline of the processor, operating as part of the normal touch processing stack without introducing additional latency or processing overhead. The machine learning model may process raw capacitive frame data in real-time at the display refresh rate, wherein the integration within the existing touch stack eliminates the need for separate processing stages or additional computational resources that would otherwise be required for input classification. By operating on raw capacitive frames as they are received from the capacitive layer, the machine learning model may classify each detected region as either a valid input or noise without requiring intermediate data transformations, buffering, or separate processing threads. This integrated architecture may reduce overall computational requirements compared to systems employing separate classification pipelines, as the machine learning inference occurs within the same processing cycle as standard touch input handling.

In some embodiments, the system may implement multi-touch finger identity disambiguation to address limitations of conventional touch tracking systems. Conventional touch tracking systems employ naive tracking behavior wherein, when a finger lifts from a first position and a different finger touches down at a second position within the same frame or within a short temporal window, the conventional system incorrectly concludes that a single finger moved from the first position to the second position. This naive tracking behavior causes finger identity confusion in multi-user scenarios, wherein touch paths are incorrectly assigned to wrong users, game interactions become confused with one user's action attributed to another user, and drawing or dragging gestures incorrectly connect unrelated touches. The present system addresses this technical limitation through a two-stage approach comprising neural network finger detection and algorithmic tracking using velocity and acceleration analysis.

In some embodiments, a gaming object may comprise a non-conductive housing with a capacitive element positioned therein, which provides several advantages over gaming objects constructed entirely from conductive materials. A non-conductive housing with a discrete capacitive element enables selective detection, wherein only the capacitive element creates a detectable signature rather than the entire object surface, thereby providing more precise and predictable capacitive signatures for identification, position determination, and orientation detection. When a gaming object is constructed entirely from conductive materials, the entire surface of the object may interact with the capacitive sensing layer, creating variable and unpredictable signatures that change based on how a user holds, touches, or manipulates the object, and that may be influenced by the user's body forming part of the conductive path. In contrast, a non-conductive housing isolates the capacitive element from incidental user contact, such that a user touching, holding, or manipulating the non-conductive portions of the gaming object does not alter the capacitive signature generated by the capacitive element. This isolation enables consistent and repeatable detection regardless of user handling, as the capacitive signature remains stable whether the user is touching the gaming object, has released the gaming object, or is manipulating the gaming object during gameplay. Furthermore, a non-conductive housing with a discrete capacitive element enables the capacitive element to be configured in a specific geometric pattern that creates a unique and distinguishable signature, whereas a fully conductive gaming object would present a uniform conductive surface lacking the distinctive spatial features necessary for reliable identification and orientation detection. The non-conductive housing also provides flexibility in aesthetic design, material selection, and manufacturing processes for the visible portions of the gaming object, while the capacitive element may be optimized independently for detection performance. Additionally, a non-conductive housing prevents the gaming object from inadvertently completing a circuit through a user's body, enabling detection of the gaming object independently of whether a user is in physical contact with the gaming object and eliminating dependency on human tissue conductivity for detection.

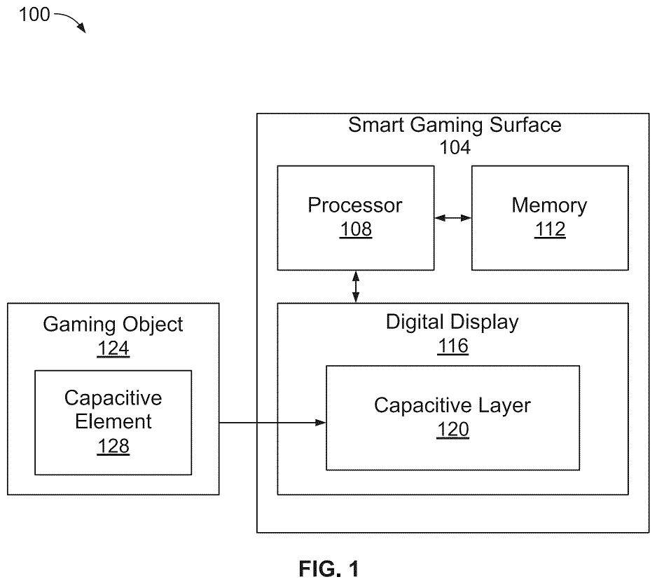

Referring now to FIG. 1, an embodiment of an interactive tangible gaming system 100 is presented. System 100 may include smart gaming surface 104. Smart gaming surface 104 may be in the shape of, but not limited to, a square, rectangle, or other shape. Smart gaming surface 104 may have a flat or curved surface profile and may be oriented in any direction including, but not limited to, facing upward in a horizontal orientation, facing forward in a vertical orientation, facing at an angle in an inclined orientation, or any other suitable orientation, such that smart gaming surface 104 may be directed in any orientation. Smart gaming surface 104 may include processor 108 and memory 112 communicatively coupled to processor 108. Memory 112 may store instructions configuring processor 108 to perform various functions. Processor 108 may include one or more central processing units (CPUs), graphics processing units (GPUs), application-specific integrated circuits (ASICs), field-programmable gate arrays (FPGAs), digital signal processors (DSPs), or combinations thereof. In some embodiments, processor 108 may include a multi-core processor configured to handle parallel processing of multiple input modalities. Processor 108 may be configured to obtain a capacitive signature of a capacitive element of a gaming object via capacitive layer 120 and cause digital display 116 to display one or more graphical elements based on the capacitive signature. Memory 112 may include volatile memory such as random access memory (RAM), including but not limited to dynamic RAM (DRAM), synchronous DRAM (SDRAM), double data rate (DDR) SDRAM (e.g., DDR4, DDR5), or low-power DDR (LPDDR) memory. Memory 112 may be configured in various capacities, such as 8 GB, 16 GB, 32 GB, 64 GB, or 128 GB, depending on system requirements. Memory 112 may further include non-volatile storage such as solid-state drives (SSDs), including but not limited to SATA SSDs, NVMe SSDs, or PCIe-based SSDs. Storage configurations may include capacities of 256 GB, 512 GB, 1 TB, 2 TB, or greater. In some embodiments, memory 112 may include a combination of RAM and SSD storage to facilitate both real-time processing and persistent data storage. In some embodiments, smart gaming surface 104 may include a battery configured to provide portable operation without connection to an external power source. The battery may include lithium-ion (Li-ion) cells, lithium-polymer (LiPo) cells, lithium iron phosphate (LiFePO4) cells, or other rechargeable battery chemistries. The battery may have a capacity of 5,000 mAh, 10,000 mAh, 20,000 mAh, 50,000 mAh, 100,000 mAh, or other suitable capacity depending on the power requirements of smart gaming surface 104 and desired operational duration. In some embodiments, the battery may provide a battery life of 2 hours, 4 hours, 6 hours, 8 hours, 10 hours, 12 hours, or longer of continuous operation depending on display brightness settings, processor utilization, application complexity, and number of active gaming objects being tracked. The battery may be rechargeable via a charging port including but not limited to USB Type-C, USB Power Delivery (USB-PD), proprietary charging connectors, or wireless charging coils. In some embodiments, smart gaming surface 104 may include a battery management system configured to monitor battery state of charge, regulate charging and discharging cycles, provide overcharge protection, provide over-discharge protection, provide thermal management, and extend battery lifespan. Smart gaming surface 104 may include battery status indicators configured to display remaining battery capacity via LEDs, on-screen indicators rendered on digital display 116, or audible notifications. In some embodiments, smart gaming surface 104 may operate in a reduced power mode when battery capacity falls below a threshold level, wherein the reduced power mode may include reduced display brightness, reduced processor clock speed, reduced touch sampling rate, or suspension of non-essential background processes to extend remaining battery life.

In some embodiments, smart gaming surface 104 may include wireless connection capabilities. Smart gaming surface 104 may include one or more wireless communication modules configured to establish wireless connections with external computing devices, networks, and services. The wireless communication modules may include but are not limited to Wi-Fi modules supporting IEEE 802.11a/b/g/n/ac/ax standards, Bluetooth modules supporting Bluetooth Classic or Bluetooth Low Energy (BLE) protocols, cellular modules supporting 4G LTE or 5G NR standards, Near Field Communication (NFC) modules, Zigbee modules, Z-Wave modules, or combinations thereof. Smart gaming surface 104 may be configured to connect to external computing devices including but not limited to cloud computing networks, remote servers, content delivery networks, gaming servers, update servers, analytics platforms, user account management systems, multiplayer matchmaking services, leaderboard services, achievement tracking systems, social networking platforms, or other networked computing resources. In some embodiments, smart gaming surface 104 may connect to a cloud network to receive software updates, firmware updates, application updates, game content updates, graphical asset updates, gaming object definition updates, capacitive signature library updates, machine learning model updates, bug fixes, security patches, feature enhancements, new game modes, downloadable content, seasonal content, event-based content, or configuration updates. Smart gaming surface 104 may transmit data to external computing devices including but not limited to gameplay telemetry, usage analytics, error logs, diagnostic information, user preferences, game state data, multiplayer session data, or achievement data. In some embodiments, processor 108 may be configured to authenticate with cloud services, manage secure connections, download and install updates, synchronize user data across multiple devices, and maintain persistent connections for real-time multiplayer functionality or live service features.

In some embodiments, processor 108 may be configured to execute one or more applications stored in memory 112. The applications may include but are not limited to gaming applications, educational applications, entertainment applications, productivity applications, simulation applications, training applications, collaborative applications, creative applications, puzzle applications, strategy applications, role-playing applications, card game applications, board game applications, trivia applications, music applications, drawing applications, mapping applications, visualization applications, presentation applications, menu applications, ordering applications, configuration applications, diagnostic applications, calibration applications, demonstration applications, tutorial applications, or combinations thereof. Processor 108 may load application code and associated data from memory 112 into volatile memory for execution. In some embodiments, processor 108 may execute multiple applications concurrently or may switch between applications based on user input received via capacitive layer 120. Processor 108 may render graphical content associated with the executing application on digital display 116 and may process inputs from gaming objects 124, touch inputs, and other detected contacts in accordance with application-specific logic and rules.

In some embodiments, smart gaming surface 104 may include digital display 116. Digital display 116 may include a liquid crystal display (LCD), an organic light-emitting diode (OLED) display, a micro-LED display, an active-matrix organic light-emitting diode (AMOLED) display, an in-plane switching (IPS) display, or other suitable display technology. Digital display 116 may have a diagonal dimension of 32 inches, 43 inches, 55 inches, 65 inches, 75 inches, 85 inches, or other suitable dimension. Digital display 116 may have a resolution of 1920×1080 pixels (Full HD), 2560×1440 pixels (QHD), 3840×2160 pixels (4K UHD), 7680×4320 pixels (8K UHD), or other suitable resolution. In some embodiments, digital display 116 may have a refresh rate of 60 Hz, 120 Hz, 144 Hz, 240 Hz, or other suitable refresh rate. Digital display 116 may have an aspect ratio of 16:9, 16:10, 4:3, 1:1, or other suitable aspect ratio. In some embodiments, digital display 116 may be configured in a horizontal orientation to facilitate face-up, shared viewing by multiple users.

Digital display 116 may be in communication with processor 108. Processor 108 may be configured to generate display frames for rendering on digital display 116. In some embodiments, processor 108 may generate display frames at a rate corresponding to the refresh rate of digital display 116, such as 60 frames per second, 120 frames per second, 144 frames per second, or 240 frames per second. Processor 108 may control digital display 116 via a display interface, including but not limited to High-Definition Multimedia Interface (HDMI), DisplayPort, embedded DisplayPort (eDP), Low-Voltage Differential Signaling (LVDS), or Mobile Industry Processor Interface (MIPI). In some embodiments, processor 108 may be configured to render graphical elements on digital display 116 in real-time in response to detected inputs from capacitive layer 120. Processor 108 may synchronize frame generation with input processing to minimize latency between user interaction and visual feedback on digital display 116. In some embodiments, processor 108 may employ double buffering or triple buffering techniques to ensure smooth frame transitions and prevent visual artifacts during rendering.

In some embodiments, digital display 116 may include capacitive layer 120. Capacitive layer 120 may be integrated into digital display 116 as an overlay positioned above the display panel, as an in-cell capacitive touch layer embedded within the display panel structure, or as an on-cell capacitive touch layer disposed between the display panel and a cover glass. Capacitive layer 120 may include a projected capacitive touch (PCT or PCAP) sensor, a surface capacitive sensor, or a mutual capacitance sensor array. In some embodiments, capacitive layer 120 may include a grid of transparent conductive elements, such as indium tin oxide (ITO), silver nanowire, copper mesh, carbon nanotube, or metal mesh conductors, arranged in rows and columns to form a sensing matrix. Capacitive layer 120 may be configured to detect changes in capacitance caused by contact with conductive objects, including but not limited to human fingers, palms, hands, elbows, knuckles, arms, feet, toes, and passive tangible objects having conductive elements. In some embodiments, capacitive layer 120 may be configured to detect multiple simultaneous contacts at different locations on digital display 116. Capacitive layer 120 may have a touch sampling rate of 60 Hz, 120 Hz, 240 Hz, or higher to enable real-time detection and tracking of inputs. In some embodiments, capacitive layer 120 may be configured to detect capacitive signatures of passive tangible objects, wherein the capacitive signatures are generated by conductive elements within or on the tangible objects without requiring onboard power or electronics. Capacitive layer 120 may be configured to provide position data, orientation data, and identity data for detected tangible objects based on the spatial arrangement of conductive patterns creating the capacitive signatures. In some embodiments, capacitive layer 120 may include a conductive pattern configured to enable determination of position and orientation of gaming object 124 on digital display 116.

System 100 may include gaming object 124. Gaming object 124 may be a passive tangible object configured for placement on and interaction with capacitive layer 120 of digital display 116. Gaming object 124 may be shaped as, but not limited to, a block, a disc, a triangle, a character figurine, a pawn, a token, a tile, a cube, a cylinder, a hexagon, a vehicle, a building, a creature, an avatar, or other geometric or representational forms. In some embodiments, gaming object 124 may be a passive tangible object having no onboard power source or active electronics. Gaming object 124 may have a non-conductive housing having a top surface, a bottom surface, and sides connected therebetween. Gaming object 124 may include the non-conductive housing, and capacitive element 128 may be positioned within or on the non-conductive housing. The non-conductive housing may be formed from materials including but not limited to injection-molded plastic, thermoformed plastic, cast resin, wood, ceramic, glass, or composite materials. In some embodiments, the non-conductive housing may include acrylonitrile butadiene styrene (ABS), polycarbonate (PC), polypropylene (PP), polyethylene (PE), nylon, acrylic, or combinations thereof.

Gaming object 124 may have capacitive element 128. Capacitive element 128 may be positioned within or on the non-conductive housing of gaming object 124. In some embodiments, capacitive element 128 may be disposed within a bottom surface of gaming object 124 to facilitate contact with or proximity to capacitive layer 120. Capacitive element 128 may include conductive materials including but not limited to conductive plastics such as thermoplastic elastomer (TPE) or polyvinyl chloride (PVC) with conductive additives, rigid printed circuit boards (PCBs), flexible printed circuit boards (FPCBs), conductive paint, conductive ink, conductive adhesive, metal foil, metal mesh, conductive fabric, or conductive polymers. In some embodiments, capacitive element 128 may include a unique conductive pattern arranged in a geometric configuration that creates a unique capacitive signature distinguishable from other gaming objects. For instance, the capacitive signature may include, but is not limited to, a pattern of three or more conductive contact points arranged in a triangular configuration, a linear array of conductive pads with varying spacing, a circular arrangement of conductive elements, an asymmetric pattern of conductive traces enabling orientation detection, a grid pattern of conductive regions, concentric conductive rings, a radial spoke pattern, or combinations thereof. The conductive pattern may include a plurality of conductive contact points, conductive traces, conductive pads, or conductive regions arranged in a predetermined spatial relationship. In some embodiments, capacitive element 128 may include a rigid PCB integrated into a molded plastic housing. In some embodiments, gaming object 124 may include mechanical interaction features configured to enable physical relationships with other gaming objects, including but not limited to nesting, stacking, interlocking, or constrained movement. The mechanical interaction features may be configured to enable nesting, stacking, or constrained movement with a second gaming object. Mechanical interaction features may include, but are not limited to, recessed edges configured to receive a portion of a second gaming object, nested cavities or receptacles configured to accept insertion of a second gaming object, stacking surfaces configured to support vertical arrangement of multiple gaming objects, interlocking protrusions and corresponding apertures, rails or channels configured to constrain movement of a second gaming object along a predetermined path or axis, rotational guides configured to constrain rotational movement of a second gaming object, snap-fit connectors, magnetic alignment features, vertical displacement mechanisms configured to enable button-like actuation, or combinations thereof. The fixed relationship between the conductive pattern of capacitive element 128 and the geometry of gaming object 124 may enable processor 108 to determine the identity, position, and orientation of gaming object 124 based on the detected capacitive signature.

Referring still to FIG. 1, capacitive element 128 may interact with capacitive layer 120. In some embodiments, gaming object 124 may include non-conductive materials such that capacitive layer 120 interacts exclusively with capacitive element 128 rather than with the body of gaming object 124. Unlike human finger touch detection, wherein capacitive sensing relies on the electrical conductivity of human tissue to form a circuit path to ground through the human body, the detection of gaming object 124 may be achieved through the localized capacitive coupling between capacitive element 128 and the sensing electrodes of capacitive layer 120 without requiring a conductive path through a human user. This configuration may enable gaming object 124 to be detected independently of whether a user is in physical contact with gaming object 124.

In some embodiments, when gaming object 124 is placed on or in proximity to capacitive layer 120, the conductive materials of capacitive element 128 may couple capacitively with the sensing electrodes of capacitive layer 120. Capacitive layer 120 may include a matrix of drive electrodes and sense electrodes arranged in rows and columns, in a diamond pattern, in an interleaved pattern, in a single-layer configuration, or in other suitable electrode arrangements. In some embodiments, when an alternating current signal is applied to the drive electrodes, an electric field may be generated between the drive and sense electrodes. The presence of capacitive element 128 within this electric field may alter the mutual capacitance between adjacent electrodes by providing a conductive path that modifies the distribution of electric field lines. The conductive pattern of capacitive element 128 may create localized changes in capacitance at multiple discrete locations corresponding to the spatial arrangement of conductive contact points within capacitive element 128. Processor 108 may sample the capacitance values across the electrode matrix at the touch sampling rate of capacitive layer 120 to generate a capacitive frame representing the spatial distribution of capacitance changes across digital display 116. Processor 108 may analyze the capacitive frame to identify clusters of capacitance changes corresponding to the conductive pattern of capacitive element 128. The geometric arrangement, spacing, and relative signal strength of the detected capacitance changes may form a capacitive signature unique to gaming object 124. Processor 108 may compare the detected capacitive signature against a library of known capacitive signatures stored in memory 112 to determine the identity of gaming object 124. Processor 108 may further compute the centroid position and rotational orientation of gaming object 124 based on the spatial coordinates of the detected capacitance changes within the capacitive frame. In some embodiments, processor 108 may track changes in the position and orientation of gaming object 124 across successive capacitive frames to enable real-time interaction between gaming object 124 and graphical elements rendered on digital display 116.

In some embodiments, processor 108 may be configured to identify individual gaming objects 124 based on capacitive signatures of their respective capacitive elements 128. In some embodiments, processor 108 may determine individual identities of a plurality of gaming objects 124 by analyzing the unique capacitive signatures generated by their respective capacitive elements 128. Processor 108 may analyze capacitive frames received from capacitive layer 120 to detect clusters of capacitance changes corresponding to conductive patterns of capacitive elements 128. For each detected cluster, processor 108 may extract spatial features including but not limited to the number of contact points, the geometric arrangement of contact points, the relative distances between contact points, the angular relationships between contact points, and the signal strength distribution across contact points. Processor 108 may compare the extracted spatial features against a library of reference capacitive signatures stored in memory 112, wherein each reference capacitive signature corresponds to a known gaming object type. In some embodiments, processor 108 may employ pattern matching algorithms, template matching, nearest neighbor classification, or machine learning classifiers to determine the identity of each detected gaming object 124. Processor 108 may compute the centroid position of each gaming object 124 based on the weighted average of the spatial coordinates of detected contact points within the capacitive frame. Processor 108 may determine the rotational orientation of each gaming object 124 based on the angular displacement of the detected conductive pattern relative to a reference orientation stored in memory 112. In some embodiments, processor 108 may track movement of gaming objects 124 across successive capacitive frames by computing displacement vectors between centroid positions in consecutive frames. Processor 108 may employ predictive tracking algorithms including but not limited to Kalman filtering, particle filtering, or velocity-based extrapolation to maintain object identity across frames and to handle temporary occlusion or sensing ambiguity. Processor 108 may maintain a tracking state for each detected gaming object 124, wherein the tracking state includes object identity, current position, current orientation, velocity, acceleration, and a confidence score. In some embodiments, processor 108 may implement object permanence logic to retain tracking state for gaming objects 124 that are temporarily undetected due to occlusion by hands, overlapping objects, or transient sensing errors. Processor 108 may update graphical elements rendered on digital display 116 in real-time based on the tracked position, orientation, and identity of each gaming object 124. Processor 108 may be configured to track a plurality of gaming objects 124 simultaneously while maintaining distinct identification for each gaming object 124 based on their respective capacitive signatures and spatial positions.

In some embodiments, processor 108 may be configured to identify specific forms of capacitive signatures and touch inputs and may ignore inputs that do not match these specific forms. Processor 108 may maintain a library of recognized capacitive signature forms stored in memory 112, wherein each recognized form corresponds to a valid input type including but not limited to registered gaming object signatures, finger touch signatures, and authorized hand configuration signatures. Processor 108 may compare detected capacitive inputs against the library of recognized forms and may reject or ignore inputs that do not match any recognized form within a configurable similarity threshold. For example, processor 108 may be configured to recognize only capacitive signatures corresponding to gaming objects that have been registered with the system, such that unregistered objects placed on capacitive layer 120 are ignored and do not trigger graphical element generation or modification on digital display 116. In another example, processor 108 may be configured to recognize only touch inputs having contact area characteristics within a predetermined range corresponding to human finger touches, such that contacts having contact areas outside the predetermined range including excessively small contacts from debris or excessively large contacts from palms or forearms are ignored. In another example, processor 108 may be configured to recognize only capacitive signatures having signal strength above a minimum threshold, such that weak or partial signatures from improperly positioned gaming objects or degraded conductive elements are ignored until the gaming object is repositioned to produce a valid signature. In another example, processor 108 may be configured to recognize only capacitive signatures exhibiting temporal stability over a minimum number of consecutive frames, such that transient electrical noise or momentary contacts are ignored. In another example, processor 108 may be configured to recognize only touch inputs exhibiting motion characteristics consistent with intentional human interaction, such that stationary contacts persisting beyond a timeout threshold without movement are reclassified as resting contacts and ignored for purposes of triggering interactive responses. In another example, processor 108 may be configured to recognize only capacitive signatures having geometric arrangements matching predefined templates stored in memory 112, such that random arrangements of conductive materials not corresponding to authorized gaming objects are ignored.

In some embodiments, processor 108 may be configured to identify sequences or patterns of touch input, gaming object input, or combinations thereof. Processor 108 may analyze temporal sequences of detected inputs to recognize predefined gesture patterns, input combinations, or interaction sequences. For example, processor 108 may detect a sequence comprising a first touch input followed by placement of gaming object 124 on capacitive layer 120 within a predetermined time window, and may trigger a corresponding action or graphical response on digital display 116. In another example, processor 108 may detect a pattern comprising rotation of gaming object 124 followed by a tap gesture via touch input adjacent to gaming object 124, and may interpret the combined sequence as a command to activate a special ability or function associated with gaming object 124. In another example, processor 108 may detect a sequence of touch inputs forming a swipe gesture originating from a first gaming object and terminating at a second gaming object, and may interpret the sequence as a transfer, connection, or interaction command between the two gaming objects. In another example, processor 108 may detect a pattern comprising simultaneous placement of two or more gaming objects 124 on capacitive layer 120 within a predetermined time window, and may trigger a cooperative or combined effect based on the simultaneous placement. In another example, processor 108 may detect a sequence comprising a long press touch input on gaming object 124 followed by a drag gesture, and may interpret the sequence as a command to move gaming object 124 along with an associated graphical element on digital display 116. Processor 108 may store predefined input sequences and patterns in memory 112 and may compare detected input sequences against the stored patterns to identify matching sequences and trigger corresponding application behaviors.

In some embodiments, processor 108 may modify digital display 116 based on interaction with touch input and/or capacitive element 128 and capacitive layer 120. Processor 108 may extract a set of spatial features from the capacitive frame, including but not limited to the number of discrete contact points, the geometric configuration of contact points, the inter-point distances measured in millimeters or pixels, the angular relationships between contact points measured in degrees or radians, the relative signal amplitude at each contact point measured in capacitance units or normalized values, and the spatial extent of the detected pattern. Processor 108 may compare the extracted spatial features against a database of reference capacitive signatures stored in memory 112, wherein each reference capacitive signature is associated with a unique object identifier corresponding to a specific gaming object type or individual gaming object. Processor 108 may further be configured to perform multi-modal input processing via capacitive layer 120, wherein multi-modal input processing includes the concurrent detection, classification, and tracking of a plurality of input types including but not limited to finger touch inputs, palm contacts, hand configurations, and passive tangible gaming objects 124.

Processor 108 may implement a unified input processing pipeline configured to receive raw capacitive frame data from capacitive layer 120 and to differentiate between input modalities at a classification stage prior to modality-specific processing. The unified input processing pipeline may be configured to handle multiple input modalities simultaneously, including but not limited to touch input, tangible object input, hand configuration input, and large-area input detection. Differentiation between input modalities may occur at the sensing and classification stage, wherein processor 108 analyzes raw capacitive frame data to classify each detected region as a specific input type before routing the classified input to modality-specific processing paths. This architecture enables processor 108 to process concurrent inputs from multiple sources while maintaining distinct tracking for each input modality, thereby supporting real-time multi-user interaction scenarios wherein multiple users may simultaneously provide finger touch inputs, manipulate gaming objects 124, and rest hands or arms on capacitive layer 120.

In some embodiments, processor 108 may employ classification algorithms including but not limited to template matching with rotation invariance, k-nearest neighbor classification, support vector machines with radial basis function kernels, decision trees, random forests, gradient boosting classifiers, neural networks, convolutional neural networks, or recurrent neural networks to match detected capacitive signatures to known object identities with a classification confidence score. Processor 108 may compute the position of each gaming object 124 by determining the centroid of the detected contact points within the coordinate system of capacitive layer 120, wherein the centroid may be calculated as a weighted average of contact point positions with weights corresponding to signal strength values, and wherein the position may be expressed in absolute coordinates, normalized coordinates, or coordinates relative to digital display 116. In some embodiments, processor 108 may be configured to differentiate between multiple input modalities in real-time via capacitive layer 120, wherein the multiple input modalities include touch input, gaming object 124 input, hand configuration input, and large-area input detection.

Processor 108 may employ multi-stage processing architectures that progressively refine detection results, spatial and temporal feature extraction for improved classification, optimized processing methods that balance accuracy and latency, and hardware acceleration utilizing available computing resources including GPUs, DSPs, or dedicated neural processing units available within processor 108. In some embodiments, processor 108 may implement various optimization techniques to maintain real-time performance, including efficient model architectures designed for low-latency operation, resource-aware processing that adapts to available computing capabilities, platform-specific optimizations for improved performance, and memory and computational footprint optimization.

In some embodiments, gaming object 124 may include a conductive region on an exterior surface thereof. The conductive region may be positioned on a top surface, side surface, or grip area of gaming object 124 and may be electrically connected to capacitive element 128. The conductive region may be formed from conductive materials including but not limited to conductive plastics, conductive paint, conductive coatings, metal inserts, or exposed conductive substrate. When a user touches the conductive region, the user's body capacitance may couple through the conductive region and the electrical connection to capacitive element 128, modifying the capacitive signature detected by capacitive layer 120. Processor 108 may be configured to detect the modification of the capacitive signature and determine that a user is in physical contact with gaming object 124. The modification may include changes in signal amplitude, signal distribution, signal shape, or other characteristics of the capacitive signature. Processor 108 may distinguish between a first state in which gaming object 124 is placed on capacitive layer 120 without user contact and a second state in which gaming object 124 is placed on capacitive layer 120 and a user is in physical contact with the conductive region. In some embodiments, processor 108 may determine varying degrees of user contact based on the magnitude of the modification, wherein a larger contact area between the user and the conductive region may produce a greater modification to the capacitive signature. Processor 108 may modify digital display 116 in response to detection of user contact with gaming object 124, including but not limited to activating graphical elements, triggering animations, changing the visual state of graphical elements associated with gaming object 124, or enabling interaction modes that are available only when a user is in physical contact with gaming object 124. The conductive region may be configured such that user contact is detectable without requiring onboard power, active electronics, mechanical switches, or wireless communication within gaming object 124.

Processor 108 may determine the orientation of each gaming object 124 by computing the angular displacement of the detected conductive pattern relative to a canonical reference orientation stored in memory 112, wherein the angular displacement may be calculated using principal component analysis to identify the major axis of the pattern, least squares fitting to match the detected pattern to a reference template, rotational template matching across a range of candidate angles, or feature-based orientation estimation using distinctive asymmetric elements of the conductive pattern. In some embodiments, processor 108 may resolve orientation ambiguity for symmetric conductive patterns by incorporating asymmetric marker elements within capacitive element 128 or by tracking rotational continuity across successive frames. Processor 108 may track movement of gaming objects 124 across successive capacitive frames by associating detected objects in each frame with tracked objects from previous frames based on spatial proximity thresholds, velocity prediction, signature similarity scores, and temporal continuity constraints. Processor 108 may compute velocity vectors for each tracked gaming object 124 based on the displacement of centroid positions between consecutive frames divided by the frame interval, wherein velocity may be expressed in units of pixels per frame, millimeters per second, or other suitable units. Processor 108 may compute acceleration vectors based on changes in velocity between consecutive frames divided by the frame interval. In some embodiments, processor 108 may employ predictive tracking algorithms including but not limited to Kalman filters with constant velocity or constant acceleration motion models, extended Kalman filters for nonlinear motion estimation, unscented Kalman filters for improved handling of nonlinear dynamics, particle filters for multi-hypothesis tracking, alpha-beta filters, alpha-beta-gamma filters, or probabilistic data association filters to estimate future positions of gaming objects 124 and to maintain tracking continuity during periods of temporary occlusion or sensing ambiguity. Processor 108 may implement a track management system configured to initialize new tracks when previously untracked gaming objects 124 are detected, to update existing tracks with new observations, to predict track positions during missed detections, and to terminate tracks after a configurable number of consecutive missed detections.

Processor 108 may maintain a persistent tracking state for each gaming object 124, wherein the tracking state includes a unique tracking identifier distinguishing the tracked instance from other instances of the same object type, object identity indicating the type or class of gaming object 124, current position coordinates in two-dimensional space, current orientation angle, velocity vector, acceleration vector, angular velocity, a timestamp of last successful detection, a count of consecutive missed detections, a track age indicating the number of frames since track initialization, and a confidence score indicating tracking reliability based on detection consistency and prediction accuracy. In some embodiments, processor 108 may implement object permanence logic configured to retain tracking state for gaming objects 124 that become temporarily undetected due to occlusion by user hands or arms, overlapping with other gaming objects 124, partial lifting from capacitive layer 120, rotation to an orientation causing reduced signal strength, or transient sensing errors, wherein the tracking state may be retained for a configurable timeout period of 100 milliseconds, 250 milliseconds, 500 milliseconds, 1 second, or other suitable duration before the gaming object 124 is considered removed from capacitive layer 120. Processor 108 may distinguish between multiple gaming objects 124 having identical object types by assigning distinct tracking identifiers based on spatial continuity across frames, such that two or more gaming objects 124 of the same type placed at different locations on capacitive layer 120 are tracked as separate entities with independent tracking states. In some embodiments, processor 108 may resolve identity ambiguity when two gaming objects 124 of the same type come into close proximity or cross paths by analyzing motion trajectories, applying velocity-based prediction, or employing probabilistic assignment algorithms including but not limited to the Hungarian algorithm, joint probabilistic data association, or multiple hypothesis tracking.

Processor 108 may detect and track compound arrangements of multiple gaming objects 124, including but not limited to stacked configurations wherein one gaming object 124 is placed atop another, nested configurations wherein one gaming object 124 is placed within a receptacle of another, adjacent configurations wherein gaming objects 124 are placed in contact or close proximity, and spatially constrained configurations wherein gaming objects 124 are arranged according to predefined spatial relationships, by analyzing the combined capacitive signatures and spatial relationships of the constituent gaming objects 124. In some embodiments, processor 108 may detect spatial relationships between gaming objects 124 including but not limited to distance between centroids, angular relationship between orientations, containment relationships, alignment relationships, and grouping relationships, and may trigger application-specific behaviors based on detected spatial relationships. Processor 108 may update graphical elements rendered on digital display 116 in real-time based on the tracked position, orientation, velocity, acceleration, angular velocity, and identity of each gaming object 124, wherein the update rate may correspond to the refresh rate of digital display 116, the sampling rate of capacitive layer 120, or a configurable application frame rate. In some embodiments, processor 108 may render graphical elements that respond dynamically to the movement and orientation of gaming objects 124, including but not limited to graphical elements that follow the position of gaming objects 124, graphical elements that rotate in correspondence with the orientation of gaming objects 124, graphical elements that scale or transform based on the velocity or acceleration of gaming objects 124, and graphical elements that appear, disappear, or change state based on spatial relationships between gaming objects 124.

Processor 108 may be configured to detect and process touch inputs from human body parts via capacitive layer 120. Processor 108 may be configured to simultaneously detect and process a plurality of input modalities comprising touch input and tangible object input via capacitive layer 120. In some embodiments, processor 108 may detect touch inputs based on capacitance changes caused by the electrical conductivity of human tissue, wherein the human body provides a conductive path to ground that alters the electric field distribution at the sensing electrodes of capacitive layer 120. Processor 108 may distinguish touch inputs from gaming object 124 inputs based on characteristics including but not limited to contact area size, signal amplitude, signal shape, temporal dynamics, and spatial distribution of capacitance changes. In some embodiments, processor 108 may detect multiple simultaneous touch inputs from one or more users interacting with capacitive layer 120 concurrently. Processor 108 may track individual touch inputs across successive capacitive frames by computing velocity and acceleration for each detected touch contact and applying physical motion constraints of human fingers to maintain contact identity. In some embodiments, processor 108 may employ velocity-based and acceleration-based tracking algorithms to handle simultaneous lift and touch events, wherein one finger is lifted from capacitive layer 120 while another finger contacts capacitive layer 120 in the same or nearby location. In some embodiments, processor 108 may detect contact angles between a human body part and capacitive layer 120 based on the shape, distribution, and signal characteristics of the detected capacitive contact region, and may modify digital display 116 accordingly based on the detected contact angle. Processor 108 may prevent finger identity swapping in dense multi-user scenarios by analyzing motion trajectories, applying temporal continuity constraints, and enforcing physical plausibility of finger movements based on biomechanical limitations of human hands. In some embodiments, processor 108 may detect and classify large-area contacts including but not limited to palm contacts, cupped hand contacts, hand edge contacts, forearm contacts, elbow contacts, and knuckle contacts as distinct input categories separate from finger touch inputs and gaming object 124 inputs.

Processor 108 may employ a machine learning-based classification model to classify detected capacitive inputs as valid inputs or noise, wherein the classification model operates directly on raw capacitive frame data from capacitive layer 120, wherein the classification model may operate as part of the normal touch processing stack without introducing additional latency. In some embodiments, the machine learning-based classification model may include a binary classifier trained to distinguish valid inputs including finger touches and gaming object 124 contacts from noise inputs including palms, arms, elbows, knuckles, and other unintended contacts. Processor 108 may be configured to classify detected capacitive inputs as valid inputs or noise using a machine learning model operating on raw capacitive frame data.

Processor 108 may implement context-aware noise filtering configured to reject noise inputs without suppressing valid inputs that are adjacent to or partially overlapping with noise regions. In some embodiments, processor 108 may detect and track valid finger touch inputs and gaming object 124 inputs even when such inputs are located immediately adjacent to regions classified as noise, thereby enabling users to rest their hands or arms on capacitive layer 120 during gameplay while continuing to interact via finger touches and gaming objects 124. Processor 108 may be configured to detect valid inputs adjacent to regions classified as noise without suppressing such valid inputs. Processor 108 may detect hand configurations including but not limited to palm positions, palm orientations, hand edges, cupped hands, and spread fingers as distinct input modalities that may be processed separately from or in conjunction with finger touch inputs and gaming object 124 inputs. In some embodiments, processor 108 may utilize detected hand configurations to infer user intent, to identify which user is performing an interaction in multi-user scenarios, or to enable gesture-based interactions distinct from discrete touch inputs. Processor 108 may process finger touch inputs, hand configurations, noise contacts, and gaming object 124 inputs concurrently through a unified multi-modal input processing pipeline, wherein differentiation between input modalities occurs at a classification stage operating on raw capacitive frame data prior to modality-specific processing paths. In some embodiments, processor 108 may implement priority-based processing wherein certain input modalities are processed before others, or wherein certain input modalities take precedence over others when conflicts arise. Processor 108 may be configured to track a plurality of touch inputs to maintain contact identity across frames by computing velocity and acceleration for each detected touch contact and applying physical motion constraints. Processor 108 may update graphical elements rendered on digital display 116 in real-time based on detected and tracked finger touch inputs, wherein the update rate corresponds to the refresh rate of digital display 116 or the sampling rate of capacitive layer 120.

In some embodiments, processor 108 may implement real-time classification to distinguish intentional touch inputs from resting hands and palms on capacitive layer 120. Processor 108 may analyze capacitive frame data to classify detected contacts as intentional touches or unintended resting contacts based on characteristics including but not limited to contact area, signal amplitude, temporal dynamics, spatial distribution, and motion patterns. The classification may occur in real-time at the sampling rate of capacitive layer 120, enabling processor 108 to filter unintended contacts without introducing perceptible latency to valid touch input processing.

In some embodiments, processor 108 may render visual feedback on digital display 116 to indicate detected noise regions to users. The visual feedback may include bounding boxes rendered as overlays around detected noise regions including palms, arms, elbows, or other unintended contacts. The bounding boxes may be displayed only when noise is detected and may be color-coded to distinguish noise regions from valid input regions. In some embodiments, the visual feedback may be configurable by application developers, wherein some applications may enable visual feedback to assist users in understanding detected noise regions while other applications may disable visual feedback to provide a seamless user experience.

In some embodiments, processor 108 may provide audio feedback to alert users when unintended touches are detected on capacitive layer 120. The audio feedback may include alert tones played when noise contacts first appear on the surface, wherein the alert tones are designed to be non-intrusive during normal gameplay. The audio feedback may be configurable by application developers, wherein audio alerts may be enabled, disabled, or customized on a per-application basis depending on the desired user experience.

In some embodiments, processor 108 may implement context-aware filtering based on simultaneous object manipulation. Processor 108 may detect and track valid finger touch inputs and gaming object 124 inputs even when such inputs are located immediately adjacent to regions classified as noise, thereby enabling users to manipulate gaming objects 124 with their fingers while their palms or hands rest on capacitive layer 120. The context-aware filtering may enable detection of gaming objects 124 being manipulated while a user's palm rests nearby, finger input detection near resting hands, and multi-user scenarios where users' arms may be positioned on the surface of digital display 116. In some embodiments, the context-aware filtering implemented by processor 108 may enable detection of gaming objects 124 being manipulated while a user's palm rests nearby on capacitive layer 120, finger input detection near resting hands positioned on capacitive layer 120, and multi-user scenarios wherein users' arms may be positioned on the surface of capacitive layer 120 without interfering with valid input detection and tracking. The context-aware filtering may be integrated into the existing touch processing pipeline without introducing additional processing overhead, and may support context-specific handling of different noise types.

In some embodiments, processor 108 may implement multi-class noise detection configured to distinguish between different types of noise contacts on capacitive layer 120. Processor 108 may classify noise contacts into distinct categories including but not limited to palm contacts, arm contacts, elbow contacts, knuckle contacts, wrist contacts, and forearm contacts based on characteristics including contact area, shape, signal amplitude distribution, and spatial extent. The multi-class noise detection may enable processor 108 to apply different handling behaviors based on the specific type of noise contact detected.

In some embodiments, processor 108 may be configured to detect and process intentional palm input as a distinct input modality. Processor 108 may detect palm orientation and palm position on capacitive layer 120 and may interpret detected palm configurations as intentional game inputs rather than noise to be rejected. Processor 108 may utilize palm orientation, palm position, or changes in palm configuration to trigger application-specific behaviors, control game elements, or provide input commands, thereby enabling users to interact with content rendered on digital display 116 using palm-based gestures in addition to finger touch inputs and gaming object inputs.

In some embodiments, processor 108 may implement adaptive filtering configured to learn individual user resting patterns to improve noise rejection accuracy. Processor 108 may analyze capacitive frame data over time to identify recurring patterns associated with individual users' typical hand positions, arm placements, and resting behaviors on capacitive layer 120. Processor 108 may store learned resting patterns in memory 112 and may utilize the learned patterns to improve classification accuracy when distinguishing between intentional inputs and unintentional resting contacts for each user.

In some embodiments, processor 108 may implement temporal analysis to distinguish stable resting contacts from transient noise on capacitive layer 120. Processor 108 may analyze time-based behavior of detected contacts including contact duration, temporal stability, and motion characteristics over successive capacitive frames. Processor 108 may classify contacts exhibiting stable, stationary behavior persisting beyond a threshold duration as resting contacts to be filtered, while classifying contacts exhibiting transient or dynamic behavior as potential intentional inputs requiring further classification. The temporal analysis may enable processor 108 to more accurately distinguish between users' hands resting on capacitive layer 120 and brief incidental contacts that may represent intentional interactions.

In some embodiments, processor 108 may implement priority-based processing wherein different input types may be processed according to application-specific requirements. Priority-based processing may enable efficient resource utilization while maintaining appropriate response characteristics for each input type. For example, processor 108 may assign higher processing priority to gaming object 124 inputs than to touch inputs in applications where tangible object manipulation is the primary interaction modality, or may assign higher processing priority to touch inputs than to gaming object 124 inputs in applications where finger-based gestures are the primary interaction modality. In some embodiments, the processing pipeline may be configured to adapt its behavior based on the specific requirements of different applications or interaction scenarios, wherein processor 108 may dynamically adjust processing priorities, sampling rates, classification thresholds, or tracking parameters based on application context, detected input density, or user-configurable settings stored in memory 112.

In some embodiments, smart gaming surface 104 may be configured to support multiple simultaneous users interacting with capacitive layer 120 concurrently. Processor 108 may detect and process inputs from a plurality of users, wherein each user may provide finger touch inputs, manipulate one or more gaming objects 124, or rest hands and arms on capacitive layer 120 simultaneously with other users. Processor 108 may analyze capacitive frame data received from capacitive layer 120 to identify and distinguish inputs originating from different users based on spatial clustering, wherein inputs detected in spatially separated regions of capacitive layer 120 may be attributed to different users positioned around smart gaming surface 104. In some embodiments, processor 108 may track user-specific inputs by associating detected touch inputs and gaming object 124 positions with designated user zones corresponding to different edges or regions of digital display 116. Processor 108 may calculate display modifications based on multiple different user inputs in real-time by processing all detected inputs within each capacitive frame, computing the effects of each input on graphical elements rendered on digital display 116, resolving conflicts or interactions between inputs from different users, and generating updated display frames reflecting the combined effects of all user inputs. In some embodiments, processor 108 may implement parallel processing paths for inputs from different users, wherein each user's inputs are processed independently before being merged into a unified display update. Processor 108 may calculate and apply display modifications at the refresh rate of digital display 116, such as 60 frames per second, 120 frames per second, or 240 frames per second, to provide real-time visual feedback to all users simultaneously. In some embodiments, processor 108 may render user-specific graphical elements oriented toward each user's position around smart gaming surface 104, such that text, menus, or interface elements are displayed in orientations readable by each respective user. Processor 108 may detect and process cooperative interactions wherein multiple users manipulate gaming objects 124 or provide touch inputs in coordination to trigger combined effects, and may detect and process competitive interactions wherein inputs from different users affect shared game state or contest for control of graphical elements on digital display 116.

In some embodiments, processor 108 may implement multi-touch finger identity disambiguation to maintain correct identification of individual finger touch inputs across successive capacitive frames. Processor 108 may track individual finger touch inputs by computing velocity vectors and acceleration vectors for each detected touch contact based on displacement between consecutive frames. Processor 108 may apply physical motion constraints of human fingers, including maximum velocity thresholds, maximum acceleration thresholds, and biomechanical limitations of finger movement, to evaluate candidate associations between detected touch contacts in successive frames. In some embodiments, processor 108 may handle simultaneous lift and touch events, wherein one finger is lifted from capacitive layer 120 while another finger contacts capacitive layer 120 in the same or nearby location within the same frame or within a short temporal window. Processor 108 may prevent finger identity swapping in dense multi-user scenarios by analyzing motion trajectories, applying temporal continuity constraints, enforcing physical plausibility of finger movements, and utilizing probabilistic assignment algorithms to associate detected contacts with tracked finger identities. In some embodiments, processor 108 may employ velocity-based and acceleration-based tracking algorithms including but not limited to Kalman filtering with motion models incorporating human finger dynamics, Hungarian algorithm for optimal assignment of detected contacts to tracked fingers, or multiple hypothesis tracking to resolve ambiguous associations when multiple fingers are in close proximity or crossing paths.

In some embodiments, processor 108 may employ a two-stage approach for multi-touch finger tracking comprising neural network finger detection and algorithmic tracking. In the first stage, a custom-trained neural network may process capacitive frames received from capacitive layer 120 to classify each detected capacitive region as a finger or not a finger, wherein the neural network outputs a set of detected finger positions per frame without providing finger identity information. In the second stage, an algorithmic tracking system may use velocity and acceleration analysis to maintain unique contact identity over time. For each detected finger position, processor 108 may compute a velocity vector based on position changes between consecutive frames and may compute an acceleration vector based on changes in velocity between consecutive frames. Processor 108 may associate detections across frames by evaluating velocity and acceleration continuity, wherein if a finger at a first position has a first velocity and first acceleration, and a new detection appears at a second position, processor 108 may calculate expected velocity and acceleration for continuation of the same contact and may compare the actual measured velocity and acceleration at the second position to the expected values. If the actual velocity and acceleration match the expected values within a threshold, processor 108 may conclude the detections represent the same finger, and if a discontinuity exists comprising a large acceleration jump or impossible velocity change, processor 108 may conclude the detections represent different fingers. Processor 108 may leverage physical constraints on human finger movement, including that fingers cannot accelerate instantaneously and maximum human finger velocity is bounded, to distinguish between continuation of an existing contact and initiation of a new contact.

In some embodiments, processor 108 may associate detections across frames by matching current frame detections to previous frame contacts based on velocity and acceleration continuity. When a finger at a first position X has a first velocity V₁ and a first acceleration A₁, and a new detection appears at a second position Y, processor 108 may calculate an expected velocity V₂ and an expected acceleration A₂ for continuation of the same contact. If the actual measured velocity and acceleration at position Y match the expected values within a threshold, processor 108 may conclude that the detections represent the same finger. If a discontinuity exists comprising a large acceleration jump or an impossible velocity change, processor 108 may conclude that the detections represent different fingers. In some embodiments, processor 108 may implement disambiguation logic for scenarios involving simultaneous lift and touch events within a single frame. When a previous frame includes a finger A at a first position X with a first velocity V₁, and a current frame includes no detection at position X indicating that finger A lifted and includes a new detection at a second position Y, processor 108 may calculate an expected position of finger A if it continued as X+V₁×Δt, may calculate the velocity and acceleration required to reach position Y from position X, and may determine that if position Y is far from the expected position and requires physically impossible acceleration, then the detection at position Y represents a different finger B rather than continuation of finger A. Processor 108 may thereby correctly classify the scenario as finger A ending and finger B beginning rather than incorrectly concluding that a single finger moved from position X to position Y.

In some embodiments, processor 108 may leverage physical constraints on human finger movement to distinguish between continuation of an existing contact and initiation of a new contact. The physical constraints may include that fingers cannot accelerate instantaneously, that maximum human finger velocity is bounded, that sudden position discontinuities with impossible acceleration indicate different fingers, and that smooth velocity and acceleration profiles indicate the same finger continuing. Processor 108 may implement these physical constraints by maintaining a maximum velocity threshold corresponding to the upper bound of human finger movement speed, such as 1000 millimeters per second, and a maximum acceleration threshold corresponding to the upper bound of human finger acceleration, such as 50000 millimeters per second squared. When evaluating candidate associations between detected contacts in successive frames, processor 108 may compute the required velocity and acceleration for each candidate association and may reject associations that would require velocity or acceleration exceeding the respective thresholds. Processor 108 may further analyze the smoothness of velocity and acceleration profiles across multiple consecutive frames, wherein smooth profiles exhibiting gradual changes in velocity and acceleration are indicative of continuous finger movement, and wherein abrupt discontinuities in velocity or acceleration profiles are indicative of distinct finger contacts. By applying these physical motion constraints, processor 108 may correctly distinguish between a single finger moving continuously across capacitive layer 120 and multiple distinct fingers contacting and lifting from capacitive layer 120 in close temporal or spatial proximity.

In some embodiments, processor 108 implementing the algorithmic tracking of the second stage may be purely algorithmic rather than machine learning-based, including real-time calculation of velocity and acceleration per contact, frame-to-frame association using motion continuity, physical constraint validation including maximum velocity thresholds and maximum acceleration thresholds, and contact lifecycle management including contact start events, contact continue events, and contact end events. The integration of machine learning finger detection with algorithmic tracking may operate such that the machine learning model provides classification of which regions are fingers, and processor 108 provides identification that a finger detected in a current frame is the same as a specific tracked finger from a previous frame. The combined system may enable robust multi-finger tracking with identity persistence across frames.

In some embodiments, the contact lifecycle managed by processor 108 may include a contact start event wherein the neural network detects a finger in a new position with no plausible previous contact based on velocity and acceleration analysis, a contact continue event wherein a detection in a current frame matches expected motion from a previous frame's contact based on velocity and acceleration continuity, and a contact end event wherein the neural network no longer detects a finger at an expected position based on predicted trajectory.

In some embodiments, processor 108 may integrate velocity and acceleration features directly into the neural network architecture, wherein the neural network may receive velocity and acceleration data as input features in addition to raw capacitive frame data to improve classification accuracy. Processor 108 may utilize machine learning to predict contact continuation versus new contact initiation, wherein a trained model may analyze motion characteristics to determine whether a detected contact in a current frame represents continuation of an existing tracked contact or initiation of a new contact. In some embodiments, processor 108 may learn user-specific motion patterns for improved accuracy, wherein processor 108 may analyze historical motion data associated with individual users to develop user-specific models that account for variations in finger movement speed, acceleration profiles, and interaction patterns among different users. Processor 108 may incorporate temporal sequence models including Long Short-Term Memory (LSTM) networks or Transformer architectures for tracking, wherein such temporal sequence models may analyze sequences of capacitive frames over time to capture temporal dependencies and improve tracking accuracy by considering the history of contact positions, velocities, and accelerations across multiple frames rather than analyzing each frame in isolation.

In some embodiments, processor 108 may generate and modify one or more graphical user interface (GUI) elements on digital display 116 in response to detection of gaming object 124 via capacitive layer 120. When capacitive layer 120 detects the capacitive signature of capacitive element 128, processor 108 may retrieve graphical asset data from memory 112 corresponding to the identified gaming object 124 and render one or more GUI elements at positions on digital display 116 corresponding to the detected position and orientation of gaming object 124. In some embodiments, processor 108 may generate GUI elements that did not previously exist on digital display 116 upon initial detection of gaming object 124, and may subsequently modify the position, orientation, scale, appearance, or state of such GUI elements in response to changes in the detected position, orientation, or spatial relationships of gaming object 124. Processor 108 may modify existing GUI elements by altering visual properties including but not limited to position coordinates, rotation angle, scale factor, opacity, color, texture, animation state, visibility, z-order, or graphical content. In some embodiments, processor 108 may generate GUI elements that represent areas of influence surrounding gaming object 124, wherein the areas of influence may affect the behavior of other GUI elements or digital content within a defined radius or region. Processor 108 may generate GUI elements that create barriers, boundaries, or routing paths that constrain or direct the movement of digital content on digital display 116. In some embodiments, processor 108 may modify GUI elements based on spatial relationships between multiple gaming objects 124, including but not limited to proximity relationships, alignment relationships, containment relationships, and grouping relationships. In some embodiments, GUI elements generated or modified by processor 108 may include text, letters, numbers, symbols, alphanumeric characters, words, phrases, sentences, paragraphs, typographic elements, punctuation marks, mathematical symbols, currency symbols, icons, glyphs, emoji, ideograms, pictograms, or combinations thereof.

In some embodiments, processor 108 may enable force-based mechanics for one or more GUI elements based on touch input and/or gaming object input. Processor 108 may generate areas of influence associated with gaming objects 124 or touch inputs that affect digital content through attraction or repulsion effects, proximity-based interactions, and other dynamic responses to object placement or touch contact. For example, processor 108 may render GUI elements that are attracted toward or repelled from gaming object 124 based on the detected position of gaming object 124 on capacitive layer 120, wherein the attraction or repulsion force may be proportional to the distance between the GUI element and gaming object 124. In another example, processor 108 may render GUI elements that respond to touch input by applying simulated gravitational, magnetic, or spring-based forces that cause the GUI elements to accelerate, decelerate, or change trajectory based on the position, velocity, or duration of the touch input. In some embodiments, multiple gaming objects 124 may create compound force effects, wherein their respective areas of influence interact to create complex behavior patterns in the digital content rendered on digital display 116. Processor 108 may calculate force vectors based on the spatial relationships between gaming objects 124, touch inputs, and GUI elements, and may update the positions, velocities, and accelerations of affected GUI elements in real-time at a rate corresponding to the refresh rate of digital display 116.

In some embodiments, processor 108 may detect and classify large-area contacts as a distinct input category separate from finger touch inputs and gaming object 124 inputs. Large-area contacts may include but are not limited to palm contacts, cupped hand contacts, hand edge contacts, forearm contacts, elbow contacts, knuckle contacts, wrist contacts, or other contacts having a contact area exceeding a predetermined threshold. Processor 108 may analyze capacitive frame data received from capacitive layer 120 to identify contiguous regions of capacitance change having spatial extent greater than the predetermined threshold, wherein the predetermined threshold may be configured to distinguish large-area contacts from finger touch inputs based on contact area measured in square millimeters, square centimeters, or pixel count. In some embodiments, processor 108 may classify large-area contacts as a distinct input category even when such contacts are rejected for purposes of triggering application interactions, wherein the classification enables processor 108 to distinguish between intentional finger touch inputs and unintentional large-area contacts such as a user resting a palm or forearm on capacitive layer 120 during gameplay. Processor 108 may maintain tracking state for detected large-area contacts including position, extent, shape, and temporal duration, and may utilize such tracking state to inform noise rejection algorithms, to provide visual feedback indicating detected but rejected contacts, or to enable application-specific behaviors responsive to large-area contacts. In some embodiments, processor 108 may detect and track large-area contacts concurrently with finger touch inputs and gaming object 124 inputs, wherein the detection and tracking of large-area contacts does not interfere with or suppress the detection and tracking of valid finger touch inputs and gaming object 124 inputs that are adjacent to, partially overlapping with, or surrounded by large-area contacts. This coexistence of input modalities may enable users to rest their hands, palms, or arms on capacitive layer 120 while continuing to interact via finger touches and gaming objects 124 without loss of input fidelity or tracking accuracy. Processor 108 may be configured to detect hand configurations comprising palm positions and orientations simultaneously with detection of gaming object 124 via capacitive layer 120.

In some embodiments, processor 108 may implement error-tolerant tracking and object permanence for gaming objects 124 detected via capacitive layer 120. Processor 108 may maintain object identity for each gaming object 124 across successive capacitive frames by associating detected capacitive signatures in each frame with tracked gaming objects 124 from previous frames based on spatial proximity, velocity prediction, signature similarity, and temporal continuity constraints. In some embodiments, processor 108 may handle temporary occlusion of gaming objects 124 caused by user hands, arms, or overlapping gaming objects by retaining tracking state for a configurable timeout period during which the gaming object 124 is not detected, wherein the timeout period may be 100 milliseconds, 250 milliseconds, 500 milliseconds, 1 second, or other suitable duration. Processor 108 may handle temporary removal of gaming objects 124 from capacitive layer 120, such as when a user briefly lifts a gaming object 124 and replaces it, by re-associating the detected capacitive signature with the previously tracked gaming object 124 based on signature matching and spatial proximity to the last known position. In some embodiments, processor 108 may maintain stable interaction state despite sensing ambiguity caused by partial occlusion, reduced signal strength due to orientation changes, overlapping capacitive signatures from adjacent gaming objects 124, or transient sensing errors in capacitive layer 120. Processor 108 may employ predictive tracking algorithms including but not limited to Kalman filtering, particle filtering, or velocity-based extrapolation to estimate positions of temporarily undetected gaming objects 124 and to maintain tracking continuity. In some embodiments, processor 108 may assign confidence scores to tracked gaming objects 124 based on detection consistency and prediction accuracy, and may utilize the confidence scores to determine when to retain tracking state during missed detections and when to terminate tracking for gaming objects 124 that have been removed from capacitive layer 120.

In some embodiments, processor 108 may provide development and testing systems configured to support creation, validation, and optimization of applications utilizing multi-modal input capabilities. The development framework may include a simulation system configured to replicate the behavior of various input types including gaming objects, touch inputs, hand configurations, and multi-user interactions without requiring physical hardware. Processor 108 may enable virtual representation and manipulation of gaming objects, generation of synthetic touch and gesture inputs, and simulation of simultaneous multi-modal interactions from multiple users. In some embodiments, the development framework may support scripting of complex input sequences for automated testing and validation purposes, wherein developers may define reproducible test scenarios comprising sequences of gaming object placements, movements, rotations, touch inputs, and multi-user interactions.

Processor 108 may provide real-time visualization of input detection and processing operations, enabling developers to observe classification decisions, tracking states, and processing pipeline behavior during development. In some embodiments, the development framework may include input simulation plugins for integration with various development environments, multi-modal event handling systems for application integration, configurable processing parameters for tuning detection and tracking behavior, and debugging tools for diagnosing input processing issues. The system may support rapid prototyping through virtual gaming object creation and modification capabilities, enabling developers to test new gaming object designs, conductive patterns, and interaction behaviors without manufacturing physical prototypes. In some embodiments, processor 108 may include automated testing tools configured to create reproducible input sequences, measure performance characteristics including latency and accuracy, validate detection and tracking behavior across different configurations, and perform regression testing to ensure consistent behavior across software updates. The testing framework may support validation of multi-user scenarios, noise rejection behavior, gaming object identification accuracy, position and orientation tracking precision, and compound interaction handling.

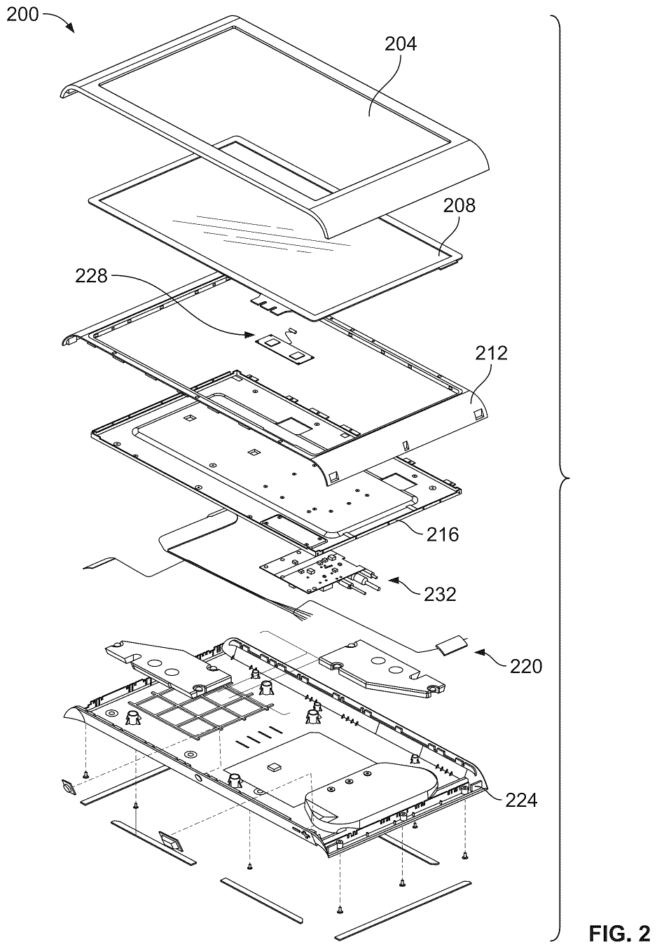

Referring now to FIG. 2, an exploded view of smart gaming surface 200 is presented. Smart gaming surface 200 may include display 204. Display 204 may be a digital display configured to render graphical content and may be substantially similar to digital display 116 described with reference to FIG. 1. Smart gaming surface 200 may include capacitive layer 208 positioned above display 204. Capacitive layer 208 may be substantially similar to capacitive layer 120 described with reference to FIG. 1 and may be configured to detect capacitive signatures from gaming objects, finger touch inputs, and other conductive contacts. Smart gaming surface 200 may include cover layer 212 positioned above capacitive layer 208. Cover layer 212 may include a protective surface configured to protect display 204 and capacitive layer 208 from physical damage, scratches, abrasion, or contamination while permitting capacitive sensing therethrough. Cover layer 212 may include materials including but not limited to tempered glass, chemically strengthened glass, sapphire glass, polycarbonate, acrylic, or other optically transparent and mechanically durable materials. In some embodiments, cover layer 212 may include an anti-glare coating, an anti-fingerprint coating, an oleophobic coating, or an anti-reflective coating. Smart gaming surface 200 may further include enclosure 216 configured to house and support display 204, capacitive layer 208, and cover layer 212. Enclosure 216 may include structural frame 220 providing mechanical support and rigidity to smart gaming surface 200. Smart gaming surface 200 may include base 224 configured to support enclosure 216 in a horizontal orientation suitable for face-up, shared viewing and interaction by multiple users. In some embodiments, smart gaming surface 200 may include electronics compartment 228 configured to house processor, memory, power supply, cooling systems, input/output ports, and other electronic components. Smart gaming surface 200 may include ventilation features 232 configured to provide airflow for thermal management of electronic components housed within enclosure 216.

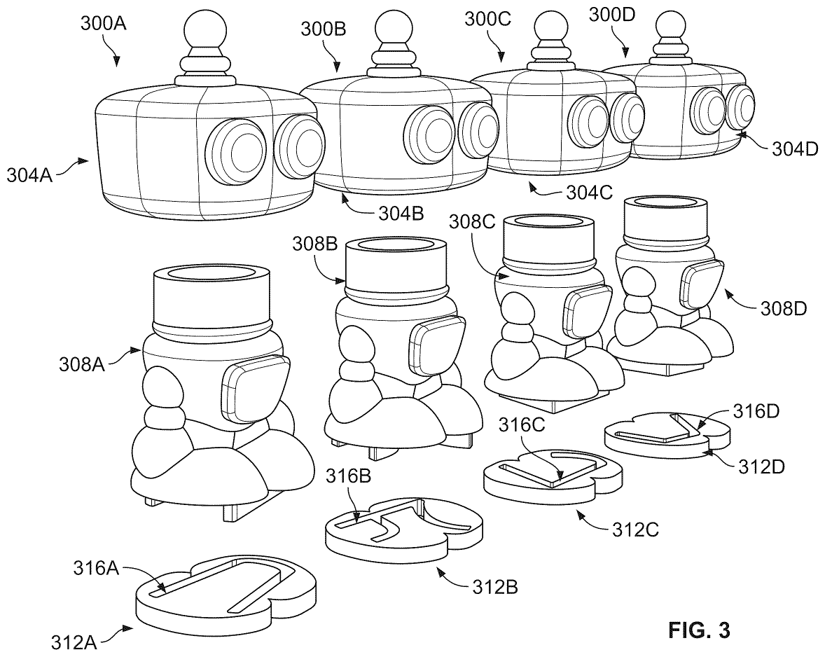

Referring now to FIG. 3, a plurality of gaming objects 300A-D according to an embodiment are presented. Gaming objects 300A-D may be passive tangible objects configured for placement on and interaction with a capacitive layer of a smart gaming surface. Gaming objects 300A-D may be in the form of robots, creatures, characters, figurines, or other representational forms. In some embodiments, gaming objects 300A-D may each include a corresponding head 304A-D, body 308A-D, bottom structure 312A-D, and capacitive element 316A-D. Head 304A-D may be positioned atop body 308A-D, and body 308A-D may be positioned atop bottom structure 312A-D. Capacitive element 316A-D may be positioned within or on bottom structure 312A-D to facilitate contact with or proximity to a capacitive layer when gaming object 300A-D is placed on a smart gaming surface. In some embodiments, gaming objects 300A-D may be identical in form, shape, and appearance. In some embodiments, gaming objects 300A-D may differ from one another in one or more characteristics including but not limited to shape, size, color, texture, surface finish, graphical markings, or visual indicia. For instance, gaming objects 300A-D may each have a different color, such that gaming object 300A is a first color, gaming object 300B is a second color different from the first color, gaming object 300C is a third color different from the first and second colors, and gaming object 300D is a fourth color different from the first, second, and third colors. In some embodiments, head 304A-D, body 308A-D, and bottom structure 312A-D may each have the same color within a single gaming object, or may have different colors within a single gaming object. In some embodiments, head 304A-D may be removably coupled to body 308A-D, and body 308A-D may be removably coupled to bottom structure 312A-D. Removable coupling may be achieved via mechanical coupling mechanisms including but not limited to snap-fit connections, friction-fit connections, magnetic connections, threaded connections, bayonet connections, tongue-and-groove connections, ball-and-socket connections, or pin-and-hole connections. In some embodiments, head 304A-D, body 308A-D, and bottom structure 312A-D may be interchangeable among gaming objects 300A-D, such that head 304A may be removably coupled to body 308B, body 308C, or body 308D, and body 308A may be removably coupled to bottom structure 312B, 312C, or 312D. In some embodiments, head 304A-D, body 308A-D, and bottom structure 312A-D may be permanently coupled via adhesive bonding, ultrasonic welding, solvent welding, insert molding, or overmolding. Capacitive element 316A-D may include a unique conductive pattern configured to generate a unique capacitive signature distinguishable from other gaming objects, such that a processor may identify each of gaming objects 300A-D based on the capacitive signature of its respective capacitive element 316A-D. In some embodiments, capacitive elements 316A-D may each have a different conductive pattern, such that gaming objects 300A-D are individually identifiable. In some embodiments, capacitive elements 316A-D may have identical conductive patterns, such that gaming objects 300A-D are identified as the same object type but are tracked as distinct instances based on spatial position.

In some embodiments, gaming objects 300A-D may be manufactured using various production-scale methods. Capacitive elements 316A-D may be formed from conductive plastics including thermoplastic elastomer (TPE) or polyvinyl chloride (PVC) compounded with conductive additives such as carbon black, carbon fiber, carbon nanotubes, graphene, metal particles, or metal-coated fibers to achieve target conductivity ranges. In some embodiments, capacitive elements 316A-D may include rigid printed circuit boards (PCBs) integrated into molded plastic housings, wherein the PCBs include conductive traces, pads, or patterns formed from copper, silver, gold, or other conductive metals using photolithographic etching, screen printing, or additive manufacturing processes. Capacitive elements 316A-D may alternatively include conductive paint or conductive ink applied to molded plastic substrates via spray coating, pad printing, screen printing, inkjet printing, or brush application. In some embodiments, gaming objects 300A-D may utilize multi-part construction separating conductive elements from structural elements, wherein capacitive elements 316A-D are manufactured separately from bottom structures 312A-D and subsequently assembled. Assembly techniques may include ultrasonic welding wherein high-frequency vibrations generate localized heat to fuse thermoplastic components, adhesive bonding using epoxy, cyanoacrylate, or pressure-sensitive adhesives to mount PCBs or conductive elements within housings, snap-fit assembly wherein mechanical interlocking features secure components without additional fasteners or adhesives, and insert molding wherein capacitive elements 316A-D are placed in a mold cavity and plastic is injected around them to encapsulate and secure the conductive elements within the molded housing. In some embodiments, gaming objects 300A-D may be manufactured using overmolding processes wherein a first material forming the capacitive element is molded, and a second material forming the non-conductive housing is subsequently molded over or around the first material. Quality control during manufacturing may include automated testing systems configured to validate object identification, signal strength, position tracking accuracy, and orientation tracking accuracy at multiple stages during production.

In some embodiments, capacitive elements 316A-D may include rigid printed circuit boards (PCBs) integrated into bottom structures 312A-D. The rigid PCBs may include copper traces forming conductive patterns configured to generate capacitive signatures detectable by a capacitive layer. Bottom structures 312A-D may be designed with a debossed area including an inset or depression formed in the shape of the PCB to receive the PCB. The PCB may include orientation notches or alignment features configured to ensure proper alignment and rotational positioning of the PCB within the debossed area during assembly. The PCB may be adhered into the debossed area using adhesive bonding including but not limited to epoxy, cyanoacrylate, or pressure-sensitive adhesive. The PCB may be positioned to sit flush with the bottom surface of bottom structures 312A-D, creating a flat surface configured for contact with a capacitive layer of a digital display. The PCB may be oriented with the copper traces facing downward in a display-side down orientation to ensure the copper traces contact or are in proximity to the capacitive surface during use. Rigid PCB integration may provide advantages including highly precise conductive patterns, excellent conductivity, and compatibility with proven manufacturing processes. Rigid PCB integration may be utilized for gaming objects requiring complex or precise conductive patterns.

In some embodiments, capacitive elements 316A-D may include conductive paint applied to injection molded plastic components of gaming objects 300A-D. Bottom structures 312A-D may be formed from base materials including but not limited to polyvinyl chloride (PVC) or acrylonitrile butadiene styrene (ABS) via injection molding processes. Bottom structures 312A-D may be injection molded with separate regions designated for conductive and non-conductive portions, wherein the conductive portions include glyph detection areas configured to generate capacitive signatures. Conductive paint may be applied to the designated conductive portions of bottom structures 312A-D to form capacitive elements 316A-D. The non-conductive portions including user touch surfaces on the top side of gaming objects 300A-D may remain unpainted or may be painted with non-conductive cosmetic paint to achieve desired aesthetic properties. The conductive paint may be applied via application methods including but not limited to spray coating, pad printing, screen printing, brush application, or dip coating. Conductive paint application may provide advantages including flexible application to various geometries and lower cost compared to PCB integration for gaming objects having simpler conductive pattern requirements.

In some embodiments, gaming objects 300A-D may be manufactured using additive manufacturing processes including three-dimensional (3D) printing. Additive manufacturing may be utilized for rapid prototyping of gaming objects to validate capacitive detection performance prior to committing to injection mold tooling, and may also be utilized for production manufacturing of gaming objects. In some embodiments, gaming objects 300A-D may be manufactured using multi-material 3D printing wherein a 3D printer having multiple print heads or filament-switching capability deposits both conductive filament and non-conductive filament in a single print operation. The conductive filament may include a thermoplastic base material compounded with conductive additives including but not limited to carbon black, carbon fiber, graphene, or metal particles, and may be deposited in regions corresponding to capacitive elements 316A-D. The non-conductive filament may comprise standard thermoplastic material and may be deposited in regions corresponding to structural body, top surface, and non-conductive portions of gaming objects 300A-D. Multi-material 3D printing may produce a single integrated gaming object with embedded conductive elements without requiring secondary assembly operations. In some embodiments, gaming objects 300A-D may be manufactured using 3D printing to produce non-conductive housings having debossed areas configured to receive rigid PCBs, wherein the PCBs are adhered into the debossed areas to form capacitive elements 316A-D, substantially similar to injection molded production pieces. In some embodiments, additive manufacturing may be utilized in a design iteration workflow comprising designing a gaming object geometry using computer-aided design (CAD) software, 3D printing a prototype gaming object with integrated conductive elements, testing capacitive detection performance of the prototype gaming object using a smart gaming surface, iterating the design based on test results, and repeating until detection performance is validated. The design iteration workflow may enable same-day or next-day fabrication and testing of prototype gaming objects, enabling exploration of multiple design variations prior to committing to production tooling. In some embodiments, additive manufacturing may be utilized as a production manufacturing method for gaming objects, including but not limited to limited-edition gaming objects, custom gaming objects, specialty gaming objects, or standard production gaming objects manufactured at any scale, wherein the conductive elements are formed during the additive manufacturing process using conductive filament or by integrating separately manufactured capacitive elements into the 3D printed housing during or after printing.

In some embodiments, gaming objects 300A-D may employ various construction techniques where conductive and non-conductive materials are combined to achieve specific detection and aesthetic characteristics. Capacitive elements 316A-D may be strategically positioned within or on the structure of gaming objects 300A-D using various assembly methods including but not limited to injection molding, mechanical fastening, or adhesive bonding. In some embodiments, the non-conductive materials of gaming objects 300A-D may be configured to provide structural support and desired aesthetic properties while allowing capacitive elements 316A-D to maintain optimal interaction with capacitive layer 120.

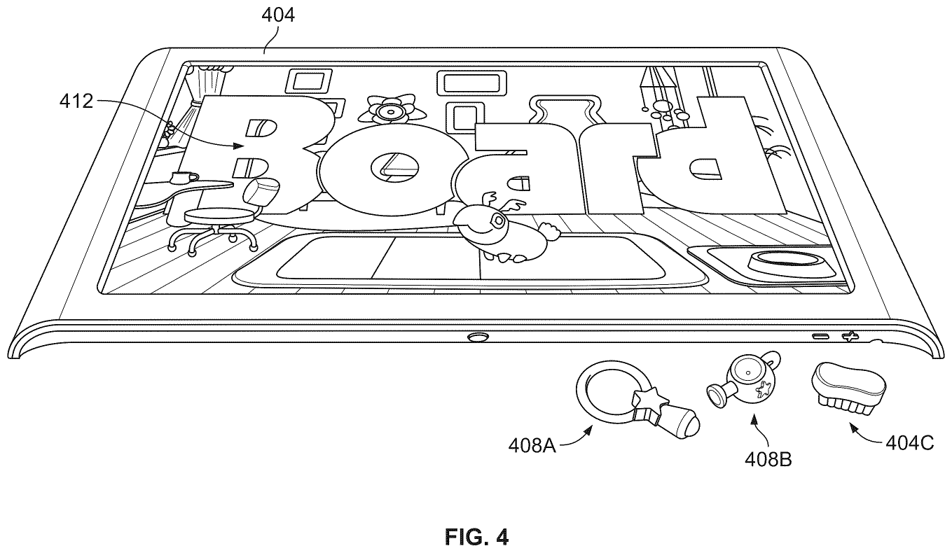

Referring now to FIG. 4, an illustration of an embodiment of a smart gaming surface 404 is presented. Smart gaming surface 404 may have display 412. Display 412 may be substantially similar to digital display 116 described with reference to FIG. 1 and may be configured to render graphical content for viewing by multiple users. In some embodiments, display 412 may be oriented horizontally to provide a face-up, shared viewing surface. Smart gaming surface 404 may be configured to support a plurality of gaming objects 408A-C positioned on display 412. Gaming objects 408A-C may be substantially similar to gaming object 124 described with reference to FIG. 1 and may each include a capacitive element configured to generate a capacitive signature detectable by a capacitive layer of display 412. In some embodiments, gaming objects 408A-C may be identical in form, shape, size, and appearance, such that gaming objects 408A-C are visually indistinguishable from one another. In some embodiments, gaming objects 408A-C may differ from one another in one or more visual characteristics including but not limited to color, pattern, texture, surface finish, graphical markings, iconography, numbering, lettering, or other visual indicia. For instance, gaming object 408A may be a first color such as red, gaming object 408B may be a second color such as blue different from the first color, and gaming object 408C may be a third color such as green different from the first and second colors. In some embodiments, a processor of smart gaming surface 404 may assign different functions to different gaming objects 408A-C based on their respective capacitive signatures, object identities, visual characteristics, or designated roles within a gaming application. For instance, gaming object 408A may be assigned a first function such as controlling a player character, spawning digital content, or activating a special ability, gaming object 408B may be assigned a second function different from the first function such as creating a barrier, defining a boundary, or modifying terrain, and gaming object 408C may be assigned a third function different from the first and second functions such as triggering an event, collecting resources, or establishing a waypoint. In some embodiments, different gaming objects may be assigned functions including but not limited to: movement functions wherein placement or movement of the gaming object causes corresponding movement of a digital avatar, character, or game piece on display 412, creation functions wherein placement of the gaming object causes generation of digital content such as buildings, obstacles, paths, or environmental features at or near the location of the gaming object, destruction functions wherein placement of the gaming object causes removal or modification of existing digital content, selection functions wherein placement of the gaming object selects, highlights, or activates digital elements beneath or adjacent to the gaming object, transformation functions wherein placement or orientation of the gaming object causes digital content to change state, appearance, or behavior, area-of-effect functions wherein the gaming object defines a zone of influence affecting digital content within a radius or region surrounding the gaming object, routing functions wherein the gaming object defines paths, channels, or trajectories for digital content to follow, barrier functions wherein the gaming object creates obstacles, walls, or boundaries that constrain movement of digital content, trigger functions wherein placement of the gaming object initiates events, animations, sequences, or state changes within the gaming application, resource functions wherein the gaming object represents, generates, collects, or transfers in-game resources, currency, or items, combat functions wherein the gaming object initiates attacks, defenses, or other competitive interactions, cooperative functions wherein multiple gaming objects placed in proximity or in specific arrangements trigger collaborative effects, or combinations thereof.

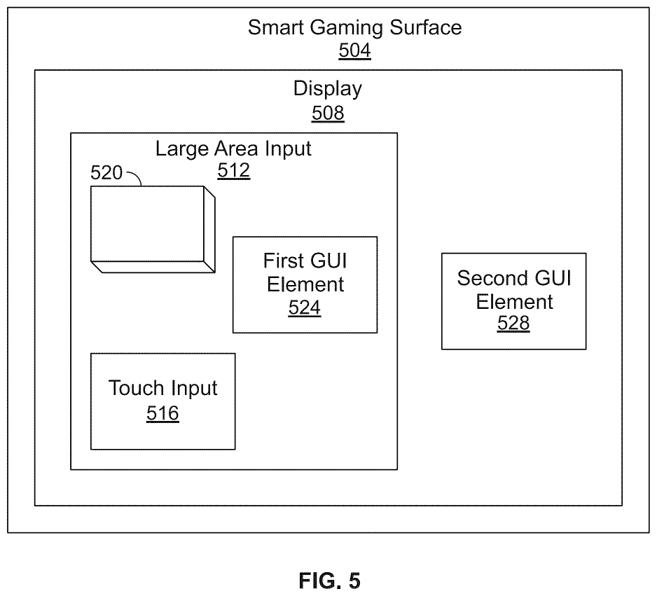

Referring now to FIG. 5, an embodiment of a smart gaming surface 504 is presented. Smart gaming surface 504 may have display 508. A processor of smart gaming surface 504 may designate an area of display 508 as large area input 512. Large area input 512 may include a region of display 508 configured to detect and respond to large-area contacts including but not limited to palm contacts, cupped hand contacts, hand edge contacts, forearm contacts, gaming object contacts, or other contacts having a contact area exceeding a threshold size. In some embodiments, the processor may designate large area input 512 by analyzing capacitive frame data received from a capacitive layer of display 508 to identify contiguous regions of capacitance change having spatial extent greater than a predetermined threshold. The predetermined threshold may be configured to distinguish large area inputs from finger touch inputs based on contact area measured in square millimeters, square centimeters, or pixel count. In some embodiments, the processor may designate large area input 512 dynamically in real-time based on detected capacitive signatures, wherein the boundaries of large area input 512 correspond to the detected extent of a large-area contact on display 508. The processor may designate large area input 512 by applying classification algorithms to raw capacitive frame data to identify regions corresponding to palms, hands, arms, or other large-area contacts as distinct from finger touch inputs and gaming object inputs. In some embodiments, the processor may render graphical elements on display 508 in response to detection of large area input 512, including but not limited to visual feedback indicating the detected region, GUI elements responsive to the position or extent of large area input 512, or modifications to existing graphical content based on the presence of large area input 512.

In some embodiments, large area input 512 may be configured to exclusively detect and respond to gaming object inputs without responding to touch inputs, or alternatively may be configured to exclusively detect and respond to touch inputs without responding to gaming object inputs, wherein the processor designates large area input 512 as a gaming object-exclusive input region or a touch-exclusive input region and ignores or rejects inputs of the non-designated modality detected within large area input 512.

In some embodiments, large area input 512 may enable simultaneous detection and processing of gaming object 520 input and touch input 516. The processor of smart gaming surface 504 may be configured to concurrently detect the capacitive signature of capacitive element of gaming object 520 and the capacitive signal generated by touch input 516 within the same capacitive frame received from the capacitive layer of display 508. In some embodiments, the processor may analyze raw capacitive frame data to identify discrete clusters of capacitance changes corresponding to gaming object 520 and touch input 516, wherein the cluster corresponding to gaming object 520 exhibits a spatial pattern matching a known capacitive signature stored in memory, and wherein the cluster corresponding to touch input 516 exhibits characteristics indicative of human finger contact including but not limited to contact area within a range of about 50 to about 200 or greater than about 200 square millimeters, signal amplitude consistent with human tissue conductivity, and temporal dynamics consistent with finger touch and release events. The processor may classify and track gaming object 520 and touch input 516 as distinct input modalities through a unified multi-modal input processing pipeline, wherein the processor assigns a first tracking identifier to gaming object 520 based on its detected capacitive signature and a second tracking identifier to touch input 516 based on its spatial position and motion characteristics. In some embodiments, the processor may detect touch input 516 when touch input 516 is positioned adjacent to gaming object 520, overlapping with a region of influence of gaming object 520, or in contact with gaming object 520, and may process both inputs independently without mutual interference. The processor may generate or modify graphical elements on display 508 in response to the combined detection of gaming object 520 and touch input 516, including but not limited to rendering graphical content associated with gaming object 520 at the detected position and orientation of gaming object 520 while simultaneously rendering touch feedback, selection indicators, or interactive responses at the detected position of touch input 516. In some embodiments, the processor may detect interactions wherein touch input 516 is used in conjunction with gaming object 520, such as a user touching display 508 adjacent to gaming object 520 to select, activate, or modify functions associated with gaming object 520, or a user providing touch input 516 to define a target location, trajectory, or parameter for an action initiated by gaming object 520. In some embodiments, gaming objects 300A-D may be constructed such that a conductive region on an exterior surface of the gaming object is electrically connected to capacitive element 316A-D. The electrical connection may be achieved through continuous conductive material extending from the capacitive element to the exterior conductive region, through conductive adhesive bonding a conductive exterior component to the capacitive element, through insert molding or overmolding that maintains electrical continuity between the capacitive element and the exterior conductive region, or through mechanical contact between conductive components assembled within the gaming object. The exterior conductive region may be formed by exposing a portion of the conductive material used in capacitive element 316A-D, by applying conductive paint or coating to an exterior surface and establishing electrical contact with capacitive element 316A-D, or by incorporating a separate conductive component connected to capacitive element 316A-D during assembly.

In some embodiments, processor of smart gaming surface 504 may implement physical constraint validation using known gaming object footprint dimensions to reject detections that are not physically possible. For example, if a detected region on capacitive layer is larger than any known gaming object footprint stored in memory and does not match finger touch characteristics, processor may classify the detected region as noise. Processor may leverage geometric constraints derived from the physical dimensions of registered gaming objects to eliminate false positive detections, wherein detected capacitive signatures that exceed maximum expected footprint dimensions or exhibit spatial characteristics inconsistent with any known gaming object type or valid finger touch are rejected from further processing.

In some embodiments, processor of smart gaming surface 504 may generate or modify first GUI element 524 on display 508 in response to detection of gaming object 520 and/or touch input 516 via the capacitive layer. When gaming object 520 is placed on display 508, the processor may generate first GUI element 524 at a position corresponding to the detected position of gaming object 520, wherein first GUI element 524 may include graphical content associated with the identity of gaming object 520 as determined from its capacitive signature. In some embodiments, first GUI element 524 may be rendered as an area of influence surrounding gaming object 520, a visual indicator of gaming object 520 status, a menu of available actions, a resource display, a character representation, or other graphical content contextually associated with gaming object 520. The processor may modify first GUI element 524 in response to changes in position, orientation, or spatial relationships of gaming object 520, such that first GUI element 524 moves, rotates, scales, or transforms in correspondence with detected changes to gaming object 520. In some embodiments, the processor may generate or modify first GUI element 524 in response to touch input 516, wherein touch input 516 detected at or adjacent to first GUI element 524 causes selection, activation, expansion, dismissal, or state change of first GUI element 524. The processor may detect combined interactions wherein touch input 516 and gaming object 520 are used in conjunction to generate or modify first GUI element 524, including but not limited to: touch input 516 selecting a target location for an action initiated by gaming object 520, wherein first GUI element 524 is generated at the location of touch input 516 in response to the combined detection, touch input 516 activating a function of gaming object 520, wherein first GUI element 524 is modified to display the result of the activated function, touch input 516 defining a trajectory or path originating from gaming object 520, wherein first GUI element 524 is generated to visualize the defined trajectory, touch input 516 adjusting a parameter associated with gaming object 520, wherein first GUI element 524 is modified to reflect the adjusted parameter value, or touch input 516 confirming or canceling an action associated with gaming object 520, wherein first GUI element 524 is modified to indicate confirmation or cancellation status. In some embodiments, the processor may generate first GUI element 524 in response to spatial relationships between gaming object 520 and touch input 516, wherein first GUI element 524 is rendered at a position determined by the relative positions of gaming object 520 and touch input 516, or wherein first GUI element 524 spans a region defined by gaming object 520 and touch input 516.

In some embodiments, processor may cause first GUI element 524 to react to gaming object 520 and/or touch input 516 via modifying one or more elements of display 508 and/or first GUI element 524. For instance, processor may modify first GUI element 524 by changing visual properties including but not limited to color, opacity, size, shape, animation state, or graphical content in response to proximity of gaming object 520 to first GUI element 524, contact between gaming object 520 and first GUI element 524, contact between touch input 516 and first GUI element 524, movement of gaming object 520 toward or away from first GUI element 524, rotation of gaming object 520 relative to first GUI element 524, or duration of touch input 516 on or adjacent to first GUI element 524. In some embodiments, processor may cause first GUI element 524 to react by triggering animations such as pulsing, glowing, expanding, contracting, rotating, bouncing, fading, highlighting, or transitioning between visual states in response to detection of gaming object 520 and/or touch input 516.

Processor may modify one or more elements of display 508 in response to interactions with gaming object 520 and/or touch input 516, including but not limited to generating particle effects emanating from first GUI element 524, rendering connection lines between gaming object 520 and first GUI element 524, displaying trajectory indicators from touch input 516 to first GUI element 524, modifying background elements of display 508 surrounding first GUI element 524, triggering environmental effects on display 508 such as ripples, waves, or lighting changes, or updating status indicators, score displays, or resource meters elsewhere on display 508 in response to interactions with first GUI element 524. In some embodiments, processor may cause first GUI element 524 to react differently based on the identity of gaming object 520 as determined from its capacitive signature, such that a first gaming object causes first GUI element 524 to display a first reaction and a second gaming object causes first GUI element 524 to display a second reaction different from the first reaction. Processor may cause first GUI element 524 to react based on combined input from gaming object 520 and touch input 516, wherein the reaction differs from reactions caused by gaming object 520 alone or touch input 516 alone.

In some embodiments, first GUI element 524 may follow movement of gaming object 520 on display 508. Processor may track the position of gaming object 520 via the capacitive layer and update the position of first GUI element 524 in real-time to correspond with the detected position of gaming object 520, such that first GUI element 524 moves in correspondence with movement of gaming object 520 across display 508. In some embodiments, gaming object 520 may be stationary on display 508 while first GUI element 524 animates to contact and/or interact with gaming object 520. Processor may render first GUI element 524 with animation sequences that cause first GUI element 524 to move toward, contact, orbit around, emanate from, or otherwise visually interact with the stationary position of gaming object 520, wherein the animation of first GUI element 524 occurs independently of any physical movement of gaming object 520. In some embodiments, first GUI element 524 may be animated as a projectile emitted from gaming object 520, wherein processor renders first GUI element 524 to originate at the detected position of gaming object 520 and to traverse across display 508 along a trajectory path. The trajectory path may include linear paths, curved paths, parabolic paths, sinusoidal paths, spiral paths, or other non-linear paths. Processor may animate first GUI element 524 to move along the trajectory path at various speeds including constant speeds, accelerating speeds, decelerating speeds, or variable speeds that change according to predefined animation curves or physics-based simulations. In some embodiments, processor may animate a plurality of first GUI elements 524 as projectiles emitted from gaming object 520 in rapid succession, in burst patterns, in spread patterns, or in other emission configurations.

In some embodiments, first GUI element 524 may follow movement of touch input 516 on display 508. Processor may track the position of touch input 516 via the capacitive layer and update the position of first GUI element 524 in real-time to correspond with the detected position of touch input 516, such that first GUI element 524 moves in correspondence with movement of touch input 516 across display 508. In some embodiments, first GUI element 524 may be animated as a projectile emitted from touch input 516, wherein processor renders first GUI element 524 to originate at the detected position of touch input 516 and to traverse across display 508 along a trajectory path. The trajectory path may include linear paths, curved paths, parabolic paths, sinusoidal paths, spiral paths, or other non-linear paths. Processor may animate first GUI element 524 to move along the trajectory path at various speeds including constant speeds, accelerating speeds, decelerating speeds, or variable speeds that change according to predefined animation curves or physics-based simulations. In some embodiments, processor may animate a plurality of first GUI elements 524 as projectiles emitted from touch input 516 in rapid succession, in burst patterns, in spread patterns, or in other emission configurations.

Display 508 may designate multiple large area inputs simultaneously, wherein the processor may detect and track a plurality of large area inputs from one or more users interacting with display 508 concurrently. Each large area input may be designated as a distinct input region based on spatial separation, wherein the processor analyzes capacitive frame data to identify multiple contiguous regions of capacitance change each having spatial extent greater than a predetermined threshold. The processor may assign unique identifiers to each detected large area input to enable independent tracking and processing. For example, a first user resting a palm on a first region of display 508 while a second user rests a palm on a second region of display 508, wherein the processor designates a first large area input corresponding to the first palm and a second large area input corresponding to the second palm. Additional examples include a single user resting both palms on display 508, wherein the processor designates two distinct large area inputs corresponding to each palm, or multiple users resting forearms, elbows, or other body parts on display 508, wherein the processor designates corresponding large area inputs for each detected contact. The processor may detect and track valid touch inputs and gaming object inputs adjacent to or between multiple large area inputs without interference, and may render graphical elements responsive to each designated large area input independently or in coordination.

Still referring to FIG. 5, display 508 may be configured to display second GUI element 528. In some embodiments, second GUI element 528 may be positioned outside of large area input 512 on display 508. Second GUI element 528 may be configured to not interact with input received via touch input 516 and/or gaming object 520, such that touch input 516 contacting second GUI element 528 does not trigger selection, activation, modification, or other interactive responses, and such that movement or placement of gaming object 520 in proximity to or overlapping with second GUI element 528 does not cause second GUI element 528 to react, change state, or otherwise respond to gaming object 520. In some embodiments, second GUI element 528 may be rendered as a non-interactive display element configured to present information, status indicators, or visual content without accepting or responding to user input via touch input 516 or gaming object 520.

In some embodiments, second GUI element 528 may be generated or modified by the processor in response to detection of gaming object 520 and/or touch input 516 via the capacitive layer, wherein second GUI element 528 is distinct from first GUI element 524 and may serve a different function or represent different information. Second GUI element 528 may be rendered at a position on display 508 that is spatially related to gaming object 520, touch input 516, first GUI element 524, or combinations thereof. In some embodiments, second GUI element 528 may include a secondary menu, a contextual tooltip, an information panel, a status indicator, a confirmation dialog, a selection highlight, a target indicator, a path visualization, a resource meter, a timer display, a score indicator, or other graphical content complementary to first GUI element 524. The processor may generate second GUI element 528 in response to specific interactions including but not limited to: placement of gaming object 520 at a predetermined location on display 508, rotation of gaming object 520 to a predetermined orientation, touch input 516 contacting a specific region of display 508, touch input 516 contacting first GUI element 524, touch input 516 contacting gaming object 520, a gesture performed via touch input 516, proximity of gaming object 520 to first GUI element 524, proximity of touch input 516 to gaming object 520, duration of touch input 516 exceeding a threshold, velocity of gaming object 520 movement exceeding a threshold, or spatial relationships between multiple gaming objects. In some embodiments, second GUI element 528 may be generated as a result of an interaction with first GUI element 524, such that touch input 516 selecting first GUI element 524 causes second GUI element 528 to appear as a submenu, detail view, or expanded information panel.

The processor may modify second GUI element 528 in response to ongoing interactions with gaming object 520 and/or touch input 516, including but not limited to updating displayed values, changing visual appearance, animating transitions, repositioning relative to gaming object 520 or touch input 516, or changing state based on detected input conditions. In some embodiments, second GUI element 528 may be configured to react to gaming object 520 and/or touch input 516 independently of first GUI element 524, or may be configured to react in coordination with first GUI element 524 such that interactions affecting first GUI element 524 also affect second GUI element 528. The processor may dismiss or hide second GUI element 528 in response to removal of gaming object 520 from display 508, cessation of touch input 516, touch input 516 outside of second GUI element 528, expiration of a timeout period, or user confirmation of an action associated with second GUI element 528.

In some embodiments, first GUI element 524 may contact second GUI element 528 on display 508. Contact between first GUI element 524 and second GUI element 528 may occur when gaming object 520 is moved to a position on display 508 such that first GUI element 524 associated with gaming object 520 overlaps, intersects, or becomes adjacent to second GUI element 528. Processor may detect contact between first GUI element 524 and second GUI element 528 by computing the spatial boundaries of each GUI element and determining whether the boundaries overlap, intersect, or are within a proximity threshold. In some embodiments, processor may trigger one or more interaction events in response to contact between first GUI element 524 and second GUI element 528, including but not limited to, merging first GUI element 524 and second GUI element 528 into a combined GUI element having properties derived from both elements, transferring data, resources, or state information from first GUI element 524 to second GUI element 528 or from second GUI element 528 to first GUI element 524, triggering animations, visual effects, or audio feedback indicating the contact event, modifying visual properties of first GUI element 524, second GUI element 528, or both in response to the contact, generating a third GUI element at the location of contact between first GUI element 524 and second GUI element 528, initiating gameplay events such as combat interactions, resource exchanges, crafting operations, or cooperative actions, destroying, consuming, or dismissing first GUI element 524, second GUI element 528, or both, or changing the state of gaming object 520 or an associated game entity based on the contact.

In some embodiments, processor may detect different types of contact between first GUI element 524 and second GUI element 528, including but not limited to collision contact wherein first GUI element 524 impacts second GUI element 528 with velocity, overlap contact wherein first GUI element 524 and second GUI element 528 occupy the same spatial region, adjacency contact wherein first GUI element 524 and second GUI element 528 are positioned within a threshold distance without overlapping, and containment contact wherein first GUI element 524 is positioned entirely within the boundaries of second GUI element 528 or vice versa. Processor may apply different interaction behaviors based on the type of contact detected. In some embodiments, processor may continuously monitor the spatial relationship between first GUI element 524 and second GUI element 528 and may trigger sustained interaction effects while contact is maintained, including but not limited to continuous resource transfer, ongoing damage or healing effects, persistent visual indicators of the contact relationship, or progressive state changes based on duration of contact. Processor may detect cessation of contact between first GUI element 524 and second GUI element 528 when gaming object 520 is moved such that first GUI element 524 no longer overlaps, intersects, or is adjacent to second GUI element 528, and may trigger corresponding separation events or restore first GUI element 524 and second GUI element 528 to pre-contact states.

In some embodiments, processor may calculate contact between gaming object 520, touch input 516, and GUI elements including first GUI element 524 and second GUI element 528 by computing spatial boundaries and determining intersection relationships. Processor may define a bounding region for each GUI element, wherein the bounding region may include a bounding box defined by minimum and maximum x-coordinates and minimum and maximum y-coordinates, a bounding circle defined by a center point and radius, a bounding polygon defined by a set of vertices, or a pixel-accurate boundary defined by the rendered graphical content of the GUI element. Processor may compute the position of gaming object 520 based on the centroid of detected capacitive contact points and may define a bounding region for gaming object 520 based on the spatial extent of the detected capacitive signature or based on predefined dimensions associated with the identified gaming object type stored in memory. Processor may compute the position of touch input 516 based on the centroid of the detected capacitive contact area and may define a bounding region for touch input 516 based on the detected contact area or based on a predefined touch radius. Processor may determine contact between gaming object 520 and a GUI element by computing whether the bounding region of gaming object 520 intersects, overlaps, or is contained within the bounding region of the GUI element using geometric intersection algorithms including but not limited to axis-aligned bounding box intersection tests, circle-circle intersection tests, circle-rectangle intersection tests, polygon-polygon intersection tests using the separating axis theorem, or point-in-polygon tests.

Processor may determine contact between touch input 516 and a GUI element by computing whether the position of touch input 516 falls within the bounding region of the GUI element or whether the bounding region of touch input 516 intersects the bounding region of the GUI element. Processor may determine contact between gaming object 520 and touch input 516 by computing whether the bounding region of gaming object 520 intersects or contains the position or bounding region of touch input 516. In some embodiments, processor may compute distance between gaming object 520, touch input 516, and GUI elements using Euclidean distance calculations between centroid positions, and may determine proximity-based contact when the computed distance falls below a configurable proximity threshold. Processor may perform contact calculations at each frame corresponding to the refresh rate of display 508 or the sampling rate of the capacitive layer to enable real-time detection of contact events and to track ongoing contact relationships across successive frames.

In some embodiments, display 508 may simultaneously present any number of GUI elements, detect any number of touch inputs, and detect any number of gaming objects, wherein the processor may process interactions among any combination of GUI elements, touch inputs, and gaming objects concurrently. The processor may detect and process interactions between a plurality of GUI elements including but not limited to first GUI element 524, second GUI element 528, and additional GUI elements rendered on display 508, wherein each GUI element may interact with any other GUI element based on spatial proximity, overlap, containment, or application-defined relationships. The processor may detect and process interactions between a plurality of gaming objects placed on display 508, wherein each gaming object may interact with any other gaming object based on spatial relationships including but not limited to proximity, alignment, stacking, nesting, or grouping, and wherein such interactions may trigger generation or modification of GUI elements, gameplay events, or state changes.

The processor may detect and process interactions between a plurality of touch inputs from one or more users, wherein each touch input may interact with any GUI element, any gaming object, or any other touch input to trigger application-defined behaviors. In some embodiments, the processor may detect compound interactions involving multiple GUI elements, multiple touch inputs, and multiple gaming objects simultaneously. For instance, a first gaming object and a second gaming object may be placed in proximity on display 508, causing a first GUI element associated with the first gaming object and a second GUI element associated with the second gaming object to overlap and trigger a merging event that generates a third GUI element representing a combined entity. In another instance, a first touch input and a second touch input from different users may simultaneously contact different regions of a single GUI element, triggering a cooperative action requiring multi-user confirmation. In another instance, a user may provide a touch input that draws a path connecting a first gaming object to a second gaming object, causing the processor to generate a GUI element representing a connection, route, or relationship between the gaming objects. In another instance, three or more gaming objects may be arranged in a spatial pattern on display 508, causing the processor to detect the pattern and generate a GUI element encompassing the arranged gaming objects, such as a boundary, zone, or area-of-effect indicator. In another instance, a touch input may contact a GUI element while a gaming object is simultaneously moved, causing the processor to apply the touch input as a modifier to an action initiated by the gaming object movement. In another instance, multiple GUI elements may chain together in response to sequential interactions, such that contact between a first GUI element and a second GUI element triggers modification of a third GUI element, which in turn affects a fourth GUI element. The processor may track all active GUI elements, touch inputs, and gaming objects and may continuously evaluate spatial relationships and interaction conditions among all detected inputs and rendered elements to enable complex, multi-entity interactions in real-time.

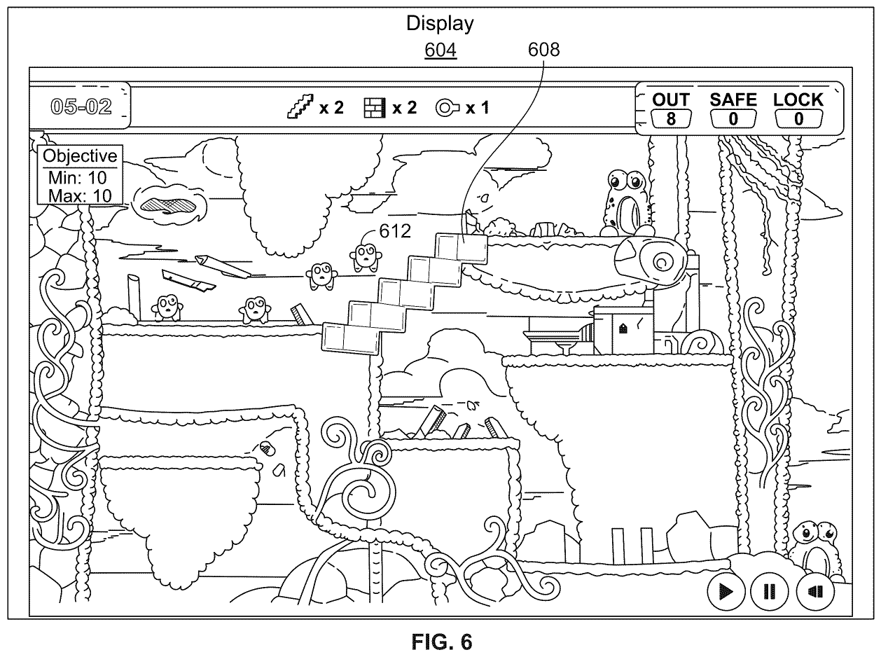

Referring now to FIG. 6, an embodiment of an application executing on a smart gaming surface is presented. Display 604 may be configured to render graphical content associated with the executing application. In some embodiments, display 604 may display one or more graphical user interface elements 612. Graphical user interface elements 612 may include fully animated creatures, characters, avatars, monsters, animals, robots, fantasy beings, mythical creatures, anthropomorphic figures, non-player characters, player-controlled characters, enemy characters, ally characters, boss characters, companion characters, collectible characters, or other animated entities. In some embodiments, graphical user interface elements 612 may be rendered with animation sequences including but not limited to idle animations, movement animations, attack animations, defense animations, interaction animations, emote animations, celebration animations, defeat animations, spawn animations, despawn animations, transformation animations, or combinations thereof. Graphical user interface elements 612 may be configured to respond dynamically to detected inputs from gaming objects, touch inputs, or spatial relationships with other graphical elements on display 604.

In some embodiments, a processor of a smart gaming surface comprising display 604 may detect gaming object 608 via a capacitive layer of display 604. The processor may detect a capacitive signature of a capacitive element of gaming object 608 and may determine the identity, position, and orientation of gaming object 608 based on the detected capacitive signature. In response to detection of gaming object 608, the processor may cause graphical user interface elements 612 to react to gaming object 608. Graphical user interface elements 612 may react to gaming object 608 by modifying visual properties, triggering animations, changing state, moving toward or away from gaming object 608, initiating interaction sequences, displaying contextual information, or otherwise responding dynamically to the detected position, orientation, or identity of gaming object 608. In some embodiments, graphical user interface elements 612 comprising fully animated creatures or characters may react to gaming object 608 by approaching gaming object 608, fleeing from gaming object 608, attacking gaming object 608, interacting with gaming object 608, orbiting around gaming object 608, or performing emote animations directed toward gaming object 608. The processor may continuously track the position and orientation of gaming object 608 and may update the reactions of graphical user interface elements 612 in real-time based on changes in the detected position, orientation, or spatial relationships of gaming object 608 on display 604. As a non-limiting example, gaming object 608 may be associated with a function of a structure, such as a tower, building, ladder, platform, or other climbable element, which one or more of graphical user interface elements 612 may climb, ascend, descend, or otherwise traverse in response to detection of gaming object 608 on display 604.

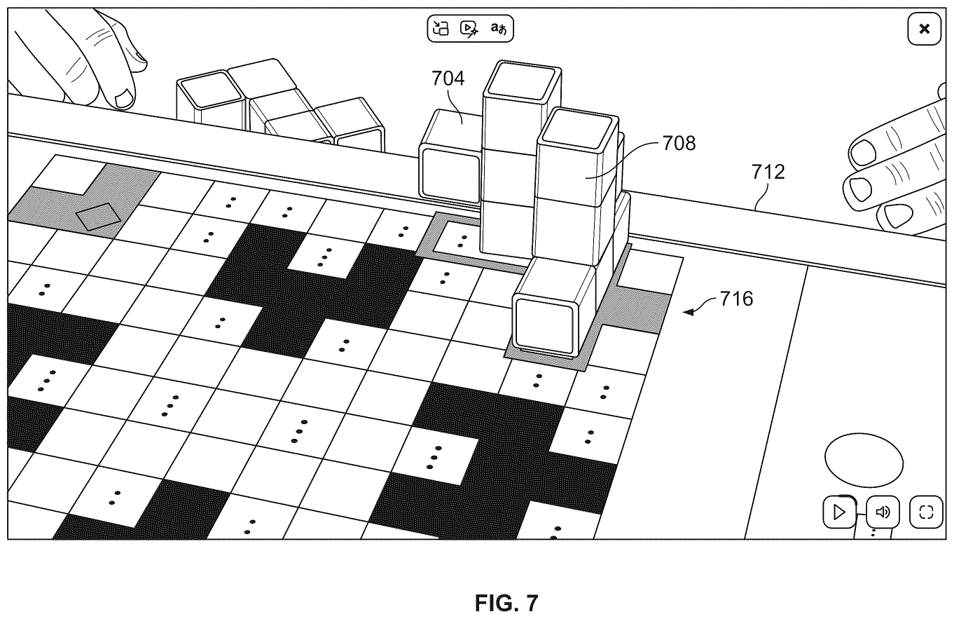

Referring now to FIG. 7, an embodiment of nested gaming objects is presented. Smart gaming surface 712 may have display 716. First gaming object 704 may be a cross-shaped object and second gaming object 708 may be an inverted t-shaped object. In some embodiments, first gaming object 704 may include a receptacle, cavity, recess, or aperture configured to receive at least a portion of second gaming object 708, such that second gaming object 708 may be nested within, inserted into, or positioned relative to first gaming object 704 in a constrained spatial relationship. The cross-shaped configuration of first gaming object 704 may define one or more recessed regions between the arms of the cross, wherein the inverted t-shaped configuration of second gaming object 708 may be positioned within one of the recessed regions. A processor of smart gaming surface 712 may detect the capacitive signatures of both first gaming object 704 and second gaming object 708 via a capacitive layer of display 716 and may determine the spatial relationship between first gaming object 704 and second gaming object 708 based on the relative positions of their respective capacitive signatures. In some embodiments, the processor may detect a nested configuration when the detected position of second gaming object 708 falls within a predetermined proximity threshold of first gaming object 704 or when the capacitive signatures of first gaming object 704 and second gaming object 708 exhibit a combined pattern indicative of nesting. The processor may trigger application-specific behaviors in response to detection of the nested configuration, including but not limited to generating graphical elements representing the combined gaming objects, modifying game state based on the nesting relationship, triggering animations or visual effects indicating successful nesting, or enabling functions that are only available when first gaming object 704 and second gaming object 708 are in the nested configuration.

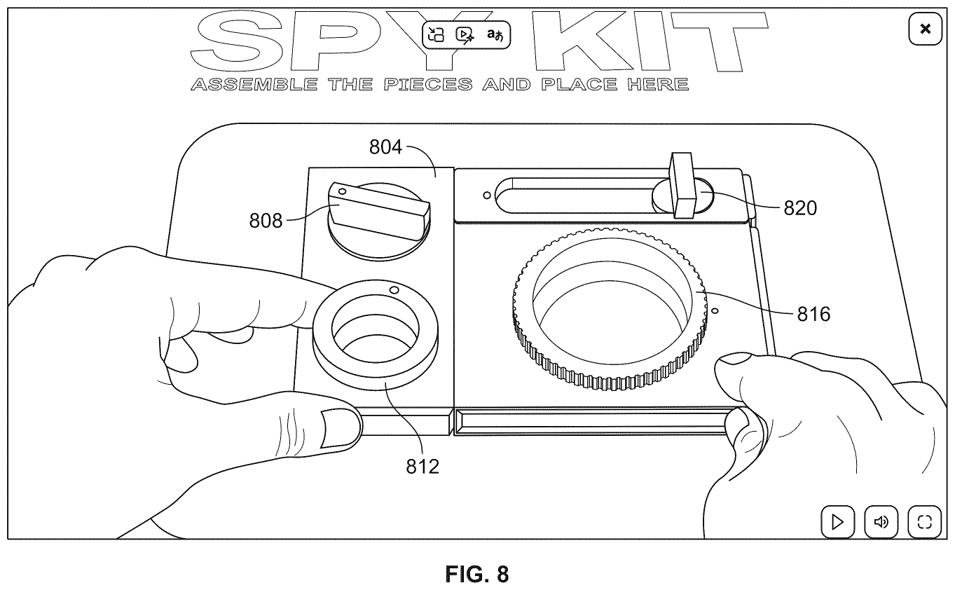

Referring now to FIG. 8, an embodiment of a multi-input gaming object 804 is presented. Multi-input gaming object 804 may have two or more input devices. For instance, multi-input gaming object 804 may have first input device 808, second input device 812, third input device 816, and fourth input device 820. First input device 808, second input device 812, third input device 816, and fourth input device 820 may each include input mechanisms including but not limited to buttons, switches, dials, sliders, joysticks, trackballs, scroll wheels, touch-sensitive surfaces, pressure-sensitive pads, or combinations thereof. In some embodiments, multi-input gaming object 804 may include a capacitive element configured to generate a capacitive signature detectable by a capacitive layer of a smart gaming surface, wherein the capacitive signature enables a processor to identify multi-input gaming object 804 and determine its position and orientation on a digital display. Multi-input gaming object 804 may be configured such that actuation of first input device 808, second input device 812, third input device 816, or fourth input device 820 causes a corresponding change in the capacitive signature detectable by the capacitive layer, thereby enabling the processor to detect input events from multi-input gaming object 804 without requiring wireless communication or onboard power. In some embodiments, each of first input device 808, second input device 812, third input device 816, and fourth input device 820 may be associated with a different function within a gaming application, such that actuation of first input device 808 triggers a first function, actuation of second input device 812 triggers a second function different from the first function, actuation of third input device 816 triggers a third function different from the first and second functions, and actuation of fourth input device 820 triggers a fourth function different from the first, second, and third functions. The processor may detect simultaneous actuation of multiple input devices and may trigger combined functions or modifier effects in response to simultaneous actuation. In some embodiments, multi-input gaming object 804 may enable a user to control multiple aspects of gameplay, including but not limited to movement, actions, abilities, selections, confirmations, cancellations, menu navigation, or parameter adjustments, through physical manipulation of the input devices while multi-input gaming object 804 remains positioned on the digital display.

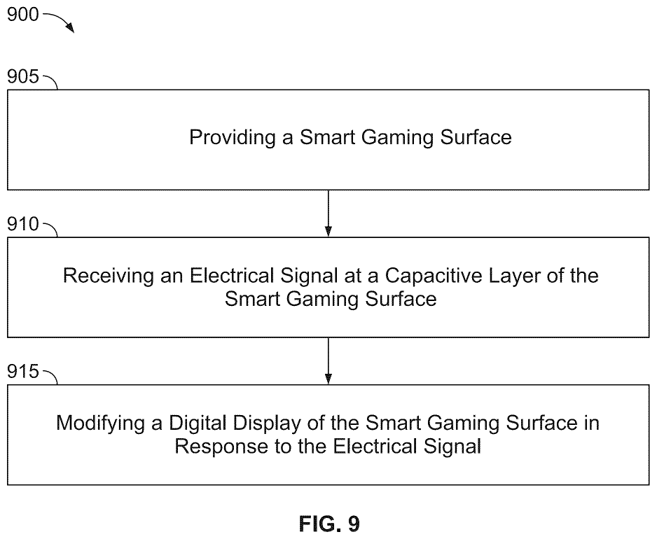

Referring now to FIG. 9, a flowchart of a method 900 of operating an interactive tangible gaming system is presented. At step 905, method 900 includes providing a smart gaming surface. The smart gaming surface may include a digital display having a capacitive layer, a processor in communication with the digital display and capacitive layer, and memory storing instructions configuring the processor to perform the operations of method 900. The smart gaming surface may be substantially similar to smart gaming surface 104 described with reference to FIG. 1 or smart gaming surface 200 described with reference to FIG. 2. In some embodiments, providing the smart gaming surface may include initializing the processor, loading application code from memory, calibrating the capacitive layer, and rendering an initial graphical user interface on the digital display.

At step 910, method 900 includes receiving an electrical signal at a capacitive layer of the smart gaming surface. The electrical signal may be generated in response to interaction between the capacitive layer and a capacitive element of a gaming object placed on or in proximity to the digital display. The electrical signal may represent a capacitive signature of the gaming object, wherein the capacitive signature is generated by conductive elements within or on the gaming object without requiring onboard power or active electronics. In some embodiments, receiving the electrical signal may include sampling capacitance values across an electrode matrix of the capacitive layer at a touch sampling rate, generating a capacitive frame representing the spatial distribution of capacitance changes across the digital display, and identifying clusters of capacitance changes corresponding to conductive patterns of gaming objects, finger touch inputs, or other conductive contacts. The processor may analyze the capacitive frame to extract spatial features including the number of contact points, the geometric arrangement of contact points, the relative distances between contact points, and the signal strength distribution across contact points. In some embodiments, the processor may classify detected capacitive inputs as valid inputs or noise using a machine learning model operating on raw capacitive frame data, wherein valid inputs include finger touches and gaming object contacts, and wherein noise includes palms, arms, elbows, knuckles, and other unintended contacts. The processor may implement context-aware noise filtering configured to reject noise inputs without suppressing valid inputs that are adjacent to or partially overlapping with noise regions.

At step 915, method 900 includes modifying a digital display of the smart gaming surface in response to the electrical signal. Modifying the digital display may include generating one or more graphical elements based on the capacitive signature of the gaming object, updating the position or orientation of existing graphical elements based on detected movement of the gaming object, triggering animations or visual effects in response to detected interactions, or changing the state of graphical elements based on spatial relationships between gaming objects, touch inputs, or other detected contacts. In some embodiments, the processor may determine the identity of the gaming object by comparing the detected capacitive signature against a library of reference capacitive signatures stored in memory, and may retrieve graphical asset data corresponding to the identified gaming object for rendering on the digital display. The processor may compute the centroid position and rotational orientation of the gaming object based on the spatial coordinates of detected capacitance changes within the capacitive frame, and may render graphical elements at positions corresponding to the detected position and orientation of the gaming object. In some embodiments, the processor may track movement of the gaming object across successive capacitive frames and may update graphical elements in real-time at a rate corresponding to the refresh rate of the digital display. The processor may detect spatial relationships between multiple gaming objects, including proximity relationships, alignment relationships, containment relationships, nesting relationships, and stacking relationships, and may trigger application-specific behaviors based on detected spatial relationships. In some embodiments, the processor may concurrently detect and process finger touch inputs, hand configurations, and gaming object inputs through a unified multi-modal input processing pipeline, and may modify the digital display based on the combined effects of all detected inputs. Any step of method 900 may be performed as described above with reference to FIGS. 1-8, without limitation.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. An interactive tangible gaming system, comprising:
a smart gaming surface comprising:
a digital display comprising a capacitive layer; and
a processor in communication with the digital display and capacitive layer; and
a gaming object configured to interact with the smart gaming surface and comprising a capacitive element having a capacitive signature, wherein upon interaction between the gaming object and the smart gaming surface, the processor is configured to:
obtain the capacitive signature via the capacitive layer; and
cause the digital display to display one or more graphical elements based on the capacitive signature.

2. The interactive tangible gaming system of claim 1, wherein the capacitive layer comprises a conductive pattern configured to enable determination of position and orientation of the gaming object on the digital display.

3. The interactive tangible gaming system of claim 1, wherein the gaming object comprises a non-conductive housing, and wherein the capacitive element is positioned within or on the non-conductive housing.

4. The interactive tangible gaming system of claim 1, wherein the processor is configured to determine an identity of the gaming object based on the capacitive signature.

5. The interactive tangible gaming system of claim 1, wherein the processor is configured to simultaneously detect and process a plurality of input modalities comprising touch input and tangible object input.

6. The interactive tangible gaming system of claim 1, wherein the processor is configured to classify detected capacitive inputs as valid inputs or noise using a machine learning model.

7. The interactive tangible gaming system of claim 1, wherein the processor is configured to detect valid inputs adjacent to regions classified as noise.

8. The interactive tangible gaming system of claim 1, wherein the processor is configured to track a plurality of touch inputs to maintain contact identity across frames.

9. The interactive tangible gaming system of claim 1, wherein the gaming object comprises mechanical interaction features configured to enable nesting, stacking, or constrained movement with a second gaming object.

10. The interactive tangible gaming system of claim 1, wherein the processor is further configured to detect hand configurations comprising palm positions and orientations simultaneously with detection of the gaming object.

11. The interactive tangible gaming system of claim 1, wherein the processor is further configured to track a plurality of gaming objects simultaneously while maintaining distinct identification for each gaming object.

12. The interactive tangible gaming system of claim 1, wherein the capacitive element comprises a conductive plastic.

13. A computer-implemented method of displaying one or more graphical elements on a display screen, comprising:
providing a smart gaming surface comprising a digital display comprising a capacitive layer;
receiving, at a processor of the smart gaming surface, an electrical signal from the capacitive layer in response to interaction between the capacitive layer and a capacitive element of a gaming object; and
modifying, via the processor of the smart gaming surface, the digital display to display the one or more graphical elements based on the interaction between the capacitive layer and the capacitive element.

14. The computer-implemented method of claim 13, further comprising tracking a plurality of touch inputs by computing velocity and acceleration for each touch input to maintain contact identity across frames.

15. The computer-implemented method of claim 13, further comprising detecting a spatial relationship between the gaming object and a second gaming object, wherein the spatial relationship comprises nesting, stacking, or constrained movement.

16. The computer-implemented method of claim 13, further comprising simultaneously detecting a hand configuration and the gaming object, wherein the hand configuration comprises a palm position or orientation.

17. The computer-implemented method of claim 13, wherein modifying the digital display comprises displaying graphical elements that respond to position, orientation, or state of the gaming object in real-time.

18. The computer-implemented method of claim 13, further comprising classifying detected capacitive inputs as valid inputs or noise using a machine learning model.

19. A gaming object for use with gaming systems, comprising:
a non-conductive housing having a top surface and a bottom surface and sides connected there between; and
a capacitive element positioned within the non-conductive housing and having a unique capacitive signature.

20. The gaming object of claim 19, wherein the capacitive element comprises a conductive pattern configured in a geometric arrangement that creates the unique capacitive signature.

21. The interactive tangible gaming system of claim 1, wherein the gaming object comprises a conductive region on an exterior surface thereof, the conductive region being electrically connected to the capacitive element.

22. The interactive tangible gaming system of claim 21, wherein the processor is configured to detect a modification to the capacitive signature caused by a user touching the conductive pattern and determine that a user is in physical contact with the gaming object.

23. The computer-implemented method of claim 13, further comprising:
detecting a modification to the capacitive signature caused by a user touching a conductive region on an exterior surface of the gaming object, the conductive region being electrically connected to the capacitive element; and
modifying the digital display in response to determining that the user is in physical contact with the gaming object.
